(19) United States
(12) Patent Application Publication
(10) Pub. No.: US 2006/0085761 A1
(43) Pub. Date: Apr. 20, 2006

(54) Text masking provider

(75) Inventors: Jay A. Allen, Redmond, WA (US); Michael R. Harsh, Kirkland, WA (US); Miguel A. Lacouture-Amaya, Sammamish, WA (US); Shawn P. Burke, Kirkland, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/968,426

(22) Filed: Oct. 19, 2004

(51) Int. Cl. G06F 3/00

(52) U.S. Cl. 715/780

(57) ABSTRACT

A system that facilitates masked data entry in an edit control is provided. More particularly, the invention can include a mask engine component that facilitates determination of a valid character from an input of one or more characters with respect to a defined format. In other words, the mask engine can compare an input character to a predefined acceptable format. An interface component that facilitates employment of the mask engine with disparate types of edit controls is also provided. The subject invention can isolate masking functionality as a service that can be interfaced into any desired edit control. For example, the masking service can be interfaced into controls including, but not limited to, a text box, a combo box, a rich edit, a list view and a cell in a data grid or the like.

### TECHNICAL FIELD

This invention is related to computer systems and more particularly to a system and/or methodology to employ core text masking logic as a service that can be utilized to incorporate masking functionality into any edit control.

### BACKGROUND OF THE INVENTION

Previous versions of object oriented programming languages (e.g., Visual Basic (VB) brand programming language) include an application-specific version of masked edit control. More particularly, these masked edit controls are specific to an individual text box within a single application and therefore, cannot be employed in connection with other controls and/or applications. Unfortunately, a text box edit control is not the only place in an application where developers can utilize the masking of text. Controls such as a combo box, rich edit, list view or even a cell in a data grid for example are all places where masking of text would be useful. In order to facilitate this versatile use of masking, there is a need to factor out the core masking logic into a service that can be used to add masking functionality to any desired edit control.

Conventionally, applications (e.g., VB, Access-brand environments) have limited support for the concept of masking with respect to a specific text edit control—e.g., text input controls restricted to a precise range of input using a language for defining masks. In other words, data masking is not available as a service that can be employed into disparate edit controls. In addition to the limited versatility, a number of shortcomings exist with these traditional approaches. For example, these approaches do not utilize predefined formats (e.g., mask wizard) to streamline a designer experience. As well, right-to-left (RTL) input and data binding are not supported. Read-only display of data is not possible in these traditional approaches. Moreover, currently, there is no mechanism available to specify optional numeric characters in a mask.

Accordingly, there exists a substantial unmet need to factor out and incorporate text “masking” functionality into a service that can be employed in connection with any control having an editable text property.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention disclosed and claimed herein, in one aspect thereof, comprises a masked edit provider. The masked edit provider can be a state engine that takes a mask string in its constructor. Once created, a user can pass characters to the state engine and request the engine to determine if the character is a valid entry based on the current state and the initial mask. In other words, the state engine can be utilized to determine if a character type (e.g., alpha numeric, numeric) matches the predefined mask.

In another aspect, the engine can also provide methods for parsing complete strings as user input. This parsing can facilitate validation of a string retrieved from an application—e.g., data store, such as a SQL database, or from a remote process via XML or another data transmission format.

In yet another example, the masking language can use ASCII characters. However, it will be appreciated that the masking language can represent any arbitrary Unicode character. The mask characters for date separators, currency symbols, etc. can be automatically localized to the current culture or any desired format. Combinations of consecutive characters into a single ligature (e.g., common in scripts such as Arabic, Devenagari and Hangul) can be handled by consumers of the provider. Those skilled in the art will appreciate that essentially any text control can be modified to use this engine to provide masking capability. The provider can also expose methods for formatting strings in accordance with the mask. As well, the invention can support options for controlling the inclusion of password characters, literal characters, or the like.

In another aspect of the subject invention, a system that facilitates data entry is provided. More particularly, the invention can include a mask engine component that facilitates determination of a valid character from an input of one or more characters with respect to a format. In other words, the mask engine can compare an input character to a predefined acceptable format. An interface component that facilitates employment of the mask engine with disparate types of edit controls is also provided. It is to be appreciated that the subject invention isolates masking functionality as a service that can be interfaced into a desired edit control. For example, the masking service can be interfaced into controls including, but not limited to, a text box, a combo box, a rich edit, a list view and a cell in a data grid or the like.

In another aspect the input can be a string whereby a parsing component can be employed to separate the string to identify the characters of the string. For example, in the case of data binding, a string input can be employed from a data base or other data store. It is to be appreciated that in connection with binding the characters to a form the service of the subject invention can be employed to assure compliance to a desired mask.

In yet another aspect, the mask engine can include a mask component and a mask analyzer component. The mask component having one or more slots facilitates defining the format that constrains the input of the one or more characters. The analyzer component facilitates determination if the input conforms to the format.

A security component that obscures a rendering of the valid character can be provided in another aspect. Likewise, a format component that facilitates generation of the mask component in accordance with the format can be included. The format component can have a wizard component. It will be appreciated that the wizard component can have one or more predefined masks. As well, the wizard component can be configured to generate user inquires thus formatting the mask based upon user input. Artificial intelligence techniques can be employed in connection with the formatting and/or wizard components to generate the mask.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a general component block diagram of a system that facilitates data entry in accordance with an aspect of the subject invention.

FIG. 2 illustrates a general component block diagram of a system that facilitates employment of a data mask in connection with constraining an input according to an aspect of the subject invention.

FIG. 3 illustrates a general component block diagram of a system that includes a mask format component and optional mask wizard component in accordance with an alternate aspect of the invention.

FIG. 4 illustrates a graphical user interface (GUI) that exemplifies the configuration of an input mask in accordance with an aspect of the invention.

FIG. 5 illustrates a general component block diagram of a system that includes a right to left (RTL) input component and a security component in accordance with an alternate aspect of the subject invention.

FIG. 6 illustrates a general component block diagram of a system that employs an alert component in accordance with an alternate aspect of the subject invention.

FIG. 7 illustrates a general component block diagram of a system that includes a sting acceptor component and a parsing component in accordance with an alternate aspect of the subject invention.

FIG. 8 illustrates an exemplary flow chart of procedures to employ an input mask in accordance with a disclosed aspect.

FIG. 9 illustrates a GUI that exemplifies the configuration of an input mask in accordance with an aspect of the invention.

FIG. 10 illustrates a general component block diagram of a system that employs an artificial intelligence component in accordance with an alternate aspect of the subject invention.

FIG. 11 illustrates a block diagram of a computer operable to execute the disclosed architecture.

FIG. 12 illustrates a schematic block diagram of an exemplary computing environment in accordance with the subject invention.

### DETAILED DESCRIPTION OF THE INVENTION

The following terms are used throughout the description, the definitions of which are provided herein to assist in understanding of various aspects of the subject invention. A “format” refers to a specific string representation of a value. By way of example, “8/10/2002” and “10.08.2002” represent the same value, but in different formats. A “mask” refers to an abstract encoding of allowable inputs into a text entry field. For example, “(nnn) nnn-nnnn” can define a mask restricting input to ten numbers (e.g., a telephone area code and phone number in the continental United States).

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention can be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The subject invention is directed to the concept of masked editing controls—e.g., text input controls restricted to a precise range of input using a simple language for defining masks. Additionally, the invention can provide canned/predefined formats/masks (e.g., wizard) that streamline designer experience. As well, right-to-left (RTL) display and data binding support can be facilitated. Additionally, a read-only property can be supported. A system and/or methodology that clears the contents without knowing about the mask and undo support are also provided. Furthermore, a method that can specify optional numeric characters in a mask are included within the scope of the subject invention.

In one aspect, the subject invention defines a novel versatile masking language that can be employed with any edit control. The described language can support arbitrary Unicode strings for languages without input method editor (IME) input. Moreover, the subject invention can support arbitrary Unicode strings without combining characters. With respect to versatility, the subject invention can create a masked text box control that can subclass TextBoxBase. An input mask wizard can be provided which includes a UITypeEditor for the mask property that allows developers to select a mask from a list of predefined boilerplates. Additionally, the subject invention imparts the ability to add and test new masks.

In operation, an event notification can be employed when a character is rejected by the mask. It is to be appreciated that any notification can be employed to alert a user of a rejected character. These alternative notifications can be predefined and/or custom error messages as desired. Further, the subject invention can retrieve the input to a masked text box with or without the mask literals included. The foregoing aspects will be better understood with reference to the description of the FIGS infra.

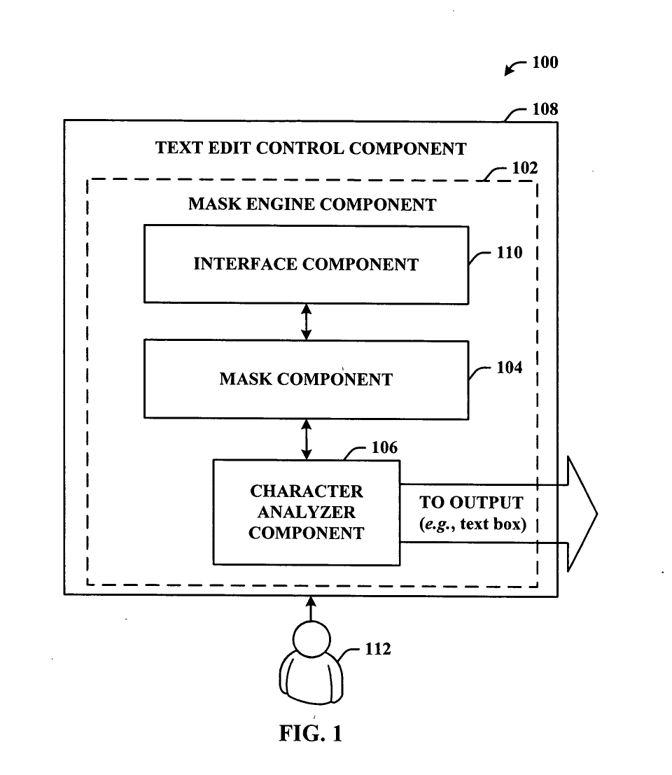

Referring initially to FIG. 1, an aspect of the subject invention that facilitates factoring out the functionality of masking text as a service is shown. Generally, the system 100 includes a mask engine component 102 having a mask component 104 and a character analyzing component 106. As illustrated, the mask engine component 102 can be employed within or in conjunction with a text edit control component 108. In accordance thereto, an interface component 110 can be provided to employ the mask engine component 108 functionality within text edit control component 108. Although the example of FIG. 1 illustrates the masking functionality (e.g., masked engine component 102) used in connection with a specific text edit control component 108, it will be appreciated that the masking functionality can be employed in any scenario whereby text masking is desired.

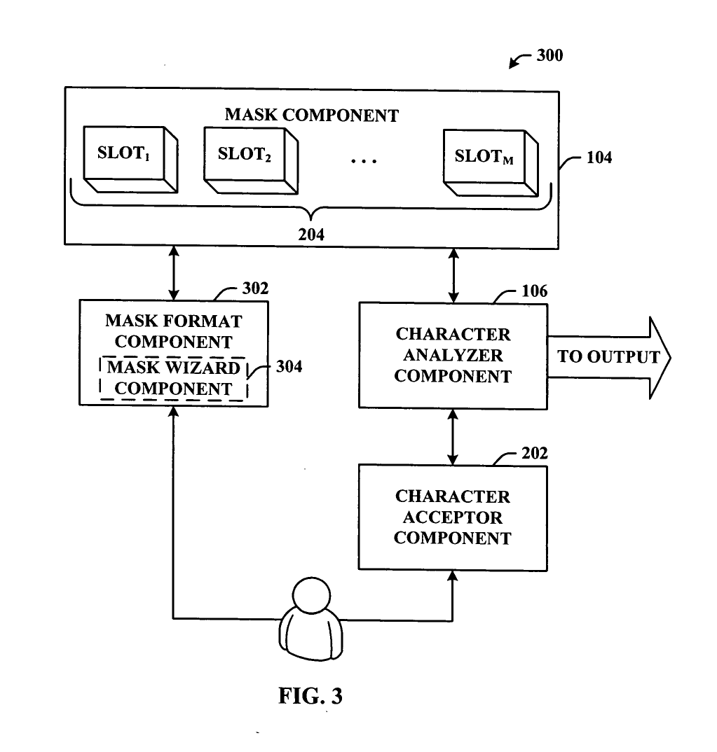

In another aspect, an optional parsing engine (not shown) can be defined as a service (e.g., class or set of classes), thus mask support can be added to any edit control and likewise be compatible with data binding. Optionally, a password character (e.g., security component (not shown) can be employed to provide desired security features. For example, a password character such as an asterisk (“*”) can be employed to visually block entry of sensitive information. The subject invention contemplates the use of this class as usable as possible via the migration wizard. Moreover, combining characters, generating noncompliance alerts, supporting RTL input, global IME support and localization of canned masks are included within the features of the subject invention. These alternate aspects will be discussed in greater detail within the discussion of FIGS. 3 though 7 infra.

Runtime Features

Continuing with the aspect illustrated in FIG. 1, the subject invention via the mask engine component 102 can define a masking language that can have parity with any existing application (e.g., VB brand design environment). For example, a mask component 104 expressible in a VB-brand environment is expressible in the managed MaskedTextBox control. The language can be an amalgam of the VB-brand MaskEdBox language and the access input mask language. In operation, a user 112 (or application (not shown)) can generate an input into the text edit control component 108, whereby the character analyzer component 106 of the mask engine component 102 can determine if the input matches the defined mask component 104.

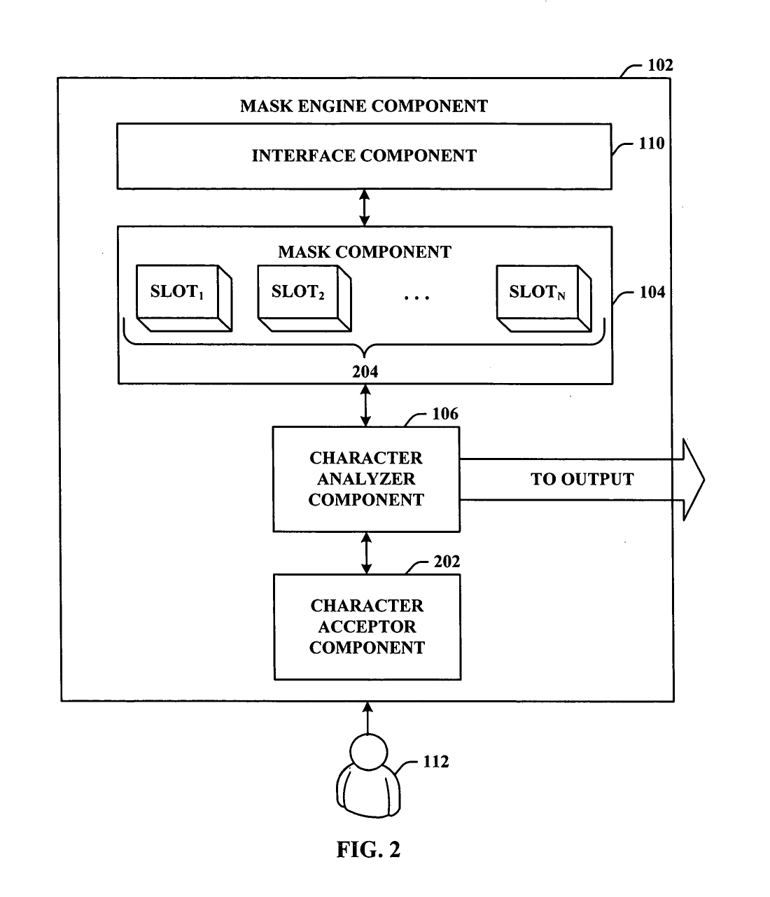

FIG. 2 illustrates a more detailed block schematic block diagram of the mask engine component 102 of FIG. 1. More particularly, the mask engine component 102 illustrated in FIG. 2 includes a mask component 104, a character analyzer component 106, an interface component 110, and a character acceptor component 202. As shown, the mask component 104 can be encoded to include multiple positions or slots 204 that represent allowable inputs. It is to be appreciated that the mask component 104 can include 1 to N slots, where N is an integer. Slots 1 to N can be referred to collectively or individually as slots 204. Additionally, the character and/or values accepted by the mask component 104 can be defined in any desired manner. For instance, the exemplary language syntax described infra can be employed to define a specific mask format.

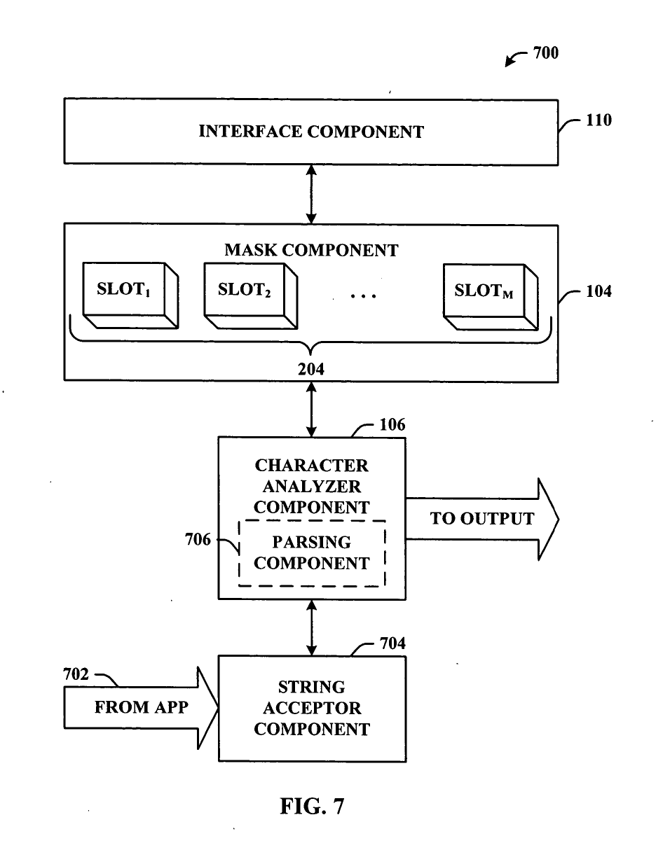

The character acceptor component 202 facilitates receiving an input from a user 112. As described supra, although the aspects of FIGS. 1 and 2 illustrate a user 112 generated input, other aspects can employ machine (e.g., application) generated inputs. By way of example, the mask engine component 102 can be employed in connection with data binding techniques whereby the input is application generated. These alternative techniques will be described in greater detail hereinafter with reference to FIG. 7.

Continuing with the example of FIG. 2, the table below presents an exemplary language syntax in accordance with an aspect of the subject invention. In other words, the table below represents an exemplary definition language that can be employed in connection with defining the acceptable inputs of slots 204 within the mask component 104. It is to appreciated that the syntax described below is provided for discussion purposes only and that any syntax and/or mask character representation can be employed in connection with the subject invention. As well, although many aspects described herein are directed to employing the mask engine component 102 in a VB-brand environment, it is to be understood that the concepts and innovations described herein and claimed hereinafter can be employed in connection with any application where a masking service is desired.

| Mask Character | |
|---|---|
| (e.g., Slot 204) | Description |
| 0 | Digit; entry required. |
| 9 | Digit or space; entry optional. |
| # | Digit or space; entry optional; blank positions converted to spaces, |
| | plus and minus signs allowed. |
| L | Required letter; Restricts input to the ASCII letters a-z and A-Z. |
| | Equivalent to [a-zA-Z] in regular expressions. Can support legacy |
| | systems (e.g., mainframes) that understand ASCII. |
| ? | Optional letter; Restricts input to the ASCII letters a-z and A-Z. |
| | Equivalent to [a-zA-Z] in regular expressions. Can support legacy |
| | systems (e.g., mainframes) that understand ASCII. |
| & | Character placeholder (required). It will be understood that a |
| | definition of a “character” can mean !System.Char.IsControl( ), which |
| | implements the proper Unicode rules for character testing. Accepts |
| | only ASCII characters if the AllowOnlyASCII property is set to true. |
| C | Character placeholder (optional). Any non-control character. Accepts |
| | only ASCII characters if the AllowOnlyASCII property is set to true. |
| A | Alphanumeric (required). Accepts only ASCII letters if the |
| | AllowOnlyASCII property is set to true. |
| A | Alphanumeric (optional). Accepts only ASCII letters if the |
| | AllowOnlyASCII property is set to true. |
| . | Decimal placeholder. The actual display character used will be based |
| | off of the decimal placeholder appropriate to the current UI culture. |
| , | Thousands placeholder. The actual display character used will be |
| | based off of the thousands placeholder appropriate to the current |
| | culture. |
| : | Time separator. The actual display character used will be based off of |
| | the time placeholder appropriate to the current culture. |
| / | Date separator. The actual display character used will be based off of |
| | the date placeholder appropriate to the current culture. |
| $ | Currency symbol. The actual character displayed will be based on the |
| | currency symbol appropriate to the current culture. |
| < | Converts all characters that follow to lowercase. (NOTE: It will be |
| | understood that in VB and Access-brand environments, there is no |
| | way to cancel lower- or upper-case conversion once begun - a user |
| | can have some characters lowercase and some uppercase, but mixed |
| | case will not be permitted). |
| > | Converts all characters that follow to uppercase. |
| \| | Character conversion is disabled on all characters that follow. |
| \ | Escapes a mask character, turning it into a literal. “\\” is the escape |
| | sequence for a backslash. |
| All other characters | Literals. An escaped literal is still a literal - e.g., the extraneous |
| | escape character is “eaten”. |

| Mask | Description |
|---|---|
| 000-00-0000 | US social security account number; all digits required. |
| (000)-000-0000 | US phone number, area code required. |
| (999)-000-0000 | US phone number, area code optional. |
| \A00000CCC-9 | Arbitrary part number, prefixed with the literal “A”, in |
| | which a five-unit alphanumeric unit is optional. |
| | Examples: “A12345ABC-9”, “A91823-4”, |
| | “A19283AB - ” |
| 990.990.990.990 | IPv5 IP address. |

The first example shown above, e.g., US social security number, the mask component 104 has eleven slots 204. In the example, the seven slots 204 are set to “0” thus, in accordance with the exemplary syntax, only a numeric digit will be accepted. As well, entry is required with respect to the above mask syntax. The “−” values represent literals which further define the format of the exemplary social security number mask. These “−” literal values represent slots four and seven of the eleven slot mask. It will be appreciated that any character or indicia can be employed as a literal in accordance with the subject invention. As well, it will be appreciated that quotation marks (e.g. “ ”) can be place around a character and/or group of characters to designate desired characters as literals.

In accordance with the mask language employed by the mask engine component 102 of the subject invention, it will be appreciated that a space can be entered into a slot 204 to designate a “null” entry for an optional character. Aspects can limit the mask 104 definition. In other words, in an aspect, non-printable characters should not be a valid input into a mask 104, even as literals.

FIG. 3 illustrates an alternate aspect of the engine of the present invention. Illustrated in FIG. 3 is a system 300 generally including a mask component 104 having a mask string identified by a number of slots 204. The character analyzer component 106 and character acceptor component 202 are provided. It will be understood that these components have the same or similar functionality as those discussed supra with reference to FIGS. 1 and 2. Moreover, the system 300 of FIG. 3 includes a mask format component 302. The mask format component 302 can facilitate configuration of the mask component 104 and corresponding slot configurations 204. In one aspect, the mask format component 302 can include a mask wizard component 304 to assist with the configuration of the mask component 104.

By way of example, the mask wizard component 304 can include any number of predefined mask components (e.g., 104) whereby a user can select from a drop down list or the like. In another example, the mask wizard component 304 can present a user with a series of questions thus formulating the mask component based upon a predefined decision mechanism. It will be understood and appreciated that the mask wizard component 304 can be configured in any manner to effect in the configuration of the mask component 104.

The following exemplary scenarios are included to provide context to the invention. It is understood that the exemplary scenarios are not provided to limit the scope and/or functionality of the invention in any way. Those skilled in the art will appreciate that the novel concepts and functionality described herein can be employed in connection with scenarios other than those described below without departing from the scope of the described and claimed invention.

The first scenario is directed to an implementation of creating the mask component 104 corresponding to an input field. More particularly, suppose a user wants to create a data entry form. In connection therewith, the user would need to add a field for a social security number. To accomplish this task, the user could add a masked text box control to the form. This can be done via the engine described with respect to the subject invention.

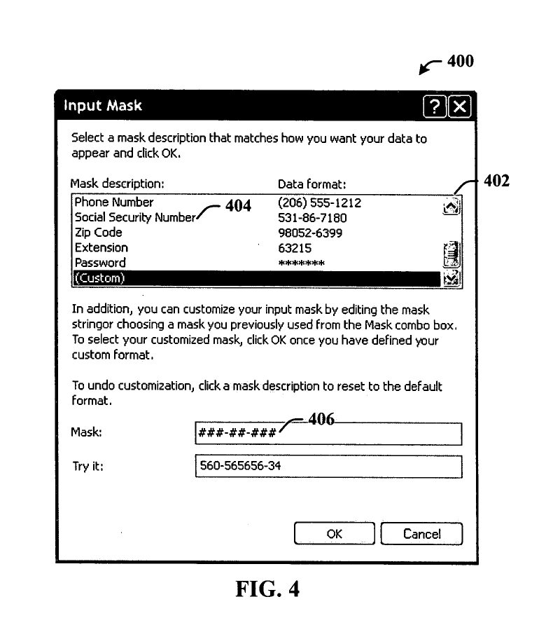

In operation, the user would select a “Mask” property in the grid on a design surface. It will be understood that any method of launching the mask service of the subject invention can be employed without departing from the scope of the specification herein. With reference now to FIG. 4, an exemplary user interface (UI) of a mask wizard component 304 (FIG. 3) is shown. Specifically, to facilitate a predefined mask selection, a selection list 402 of canned masks can be displayed. From the selection list 402, the user can choose the “Social Security Number” (SSN) mask 404 and the appropriate mask string 406 is set to the property representing slots 204 of FIG. 3.

As a result, a masked text box employing the predefined “SSN mask” 404 is added to the form. In the designer and at runtime, the mask string 406 is displayed in the masked text box control. As a result, only characters that meet the mask string 406 criteria will be accepted.

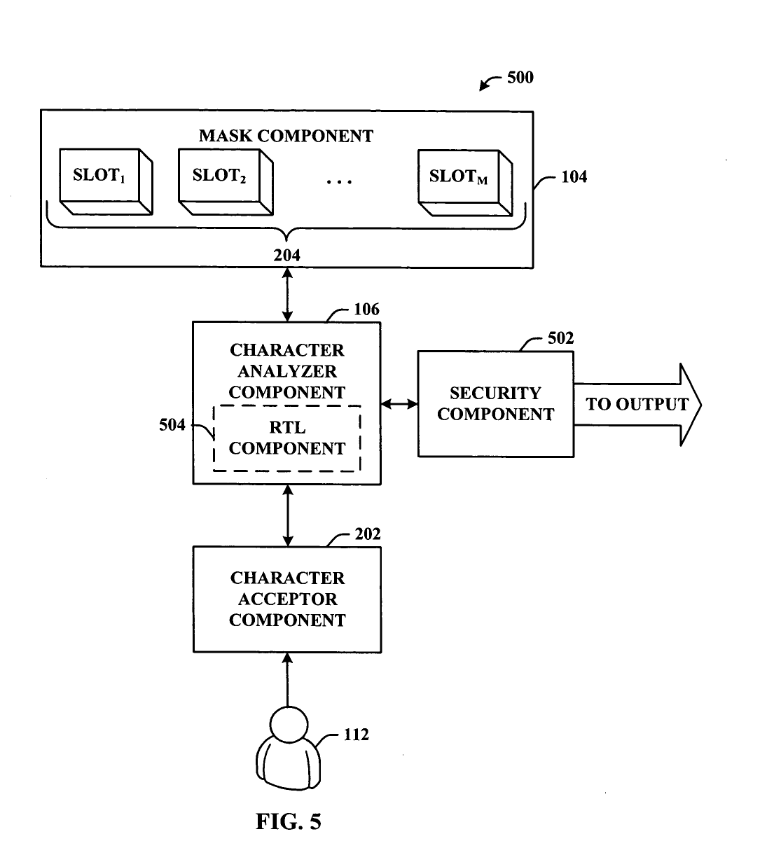

FIG. 5 illustrates an alternate aspect of the subject invention. More particularly, FIG. 5 illustrates a system 500 that includes the mask component 104 having slots 204 defined therein. The system 500 further includes the character analyzer component 106 and the character acceptor component 202. It will be understood that these components will have the same or similar functionality as described supra. Additionally, the system 500 can further include a security component 502 that can restrict display of the input thus eliminating the risk of an unauthorized party obtaining and/or using the masked input. For example, the security component 502 can employ password character integration that hides, obscures and/or does not display the input character with respect to the predefined slots 204 of the mask 104. This functionality is described with reference to the following scenario.

In this example, suppose a user works for a financial institution. The SSN field created in the first scenario is one piece of data a user supplies to assure confidentiality and to view their bank balances online. Because of the confidentiality of a SSN, the Bank would like to obscure this number so that a person looking over the customer's shoulder at a public kiosk cannot filch the confidential SSN. In accordance thereto, the designer assigns an asterisk (“*”) to PasswordChar in connection with the security component 502 on the masked text box. The mask component 104 is still enforced, however, the security component 502 effects that all typed characters are represented by the asterisk instead of shown directly. The Bank can later query the system (e.g., call MaskedTextBox1.OutputText) and get the SSN with its literals and the actual values supplied by the customer.

A third scenario is related to the RTL behavior of masking. With continued reference to FIG. 5, assume the designer 112 is developing a form for the Israeli market and in accordance therewith needs to support the Hebrew language. Accordingly, as illustrated, the character analyzer component 106 can include an optional RTL component 504. A masked text box control that utilizes system 500 with a mask 104 defined for telephone numbers is to be employed. When the designer 112 tests the form with RightToLeft=“True”, it is noticed that the mask 104 functions correctly in RTL mode (e.g., the text flows from right to left) substitutions effect in the correct order, and deletions in the middle of the mask work fine.

Additionally, the masked text box is not flummoxed by the use of non-Latin characters. In other words, the letter and alphanumeric mask characters allow the use of the Hebrew alphabet without incident, and any non-letter or non-printable characters in the Hebrew Unicode code range are recognized as such by the character analyzer component 106 and rejected.

The following scenario relates to creating a custom mask. Suppose the designer would like to employ masked text box, but is developing an application for the Japanese market. In accordance thereto, a phone number and date mask are needed to comply with the Japanese region. In order to do so, the designer can open the editor for the masked text box's mask property, and define two new masks to represent the localized inputs. The masks are then tested in a “Try It” text box in connection with the input mask wizard. Once satisfied, the masks can be associated with the desired edit control. Finally, the designer's settings can be saved within the visual designer, and are available for future use in other projects.

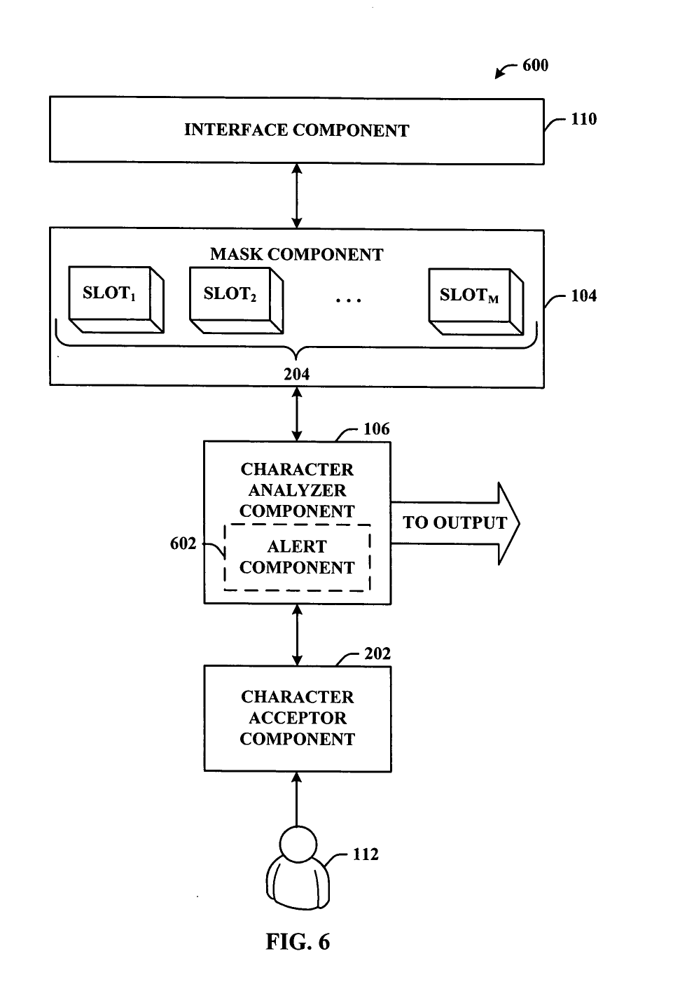

Referring now to FIG. 6, yet another scenario is directed to event handling for the mask 104 input. Suppose a designer does not want users to become frustrated when using a masked text box system 600. In other words, the designer would like the system 600 to alert the user in the instance of an input that is not valid with respect to the mask 104. Specifically, in the event that an input does not match the predetermined acceptable character for a particular slot 204, the designer would like to employ an alert.

Instead of a default beep given when a non-matching character is input, the designer wants to display balloon help in the form of the operating system (OS) (e.g., Windows XP brand OS) password “Caps Lock is ON” notification. In order to facilitate this action, as illustrated, system 600 can include the character analyzer component 106 that includes an optional alert component 602. It will be appreciated that the alert component 602 can facilitate any desired notification including, but not limited to, audible alerts, visual alerts, hints, errors codes, etc.

Continuing with the scenario, in one aspect, the MaskInputRejected can be handled as shown in the exemplary code below:

Protected Sub MaskedTextBox1_OnMaskInputRejected(Object sender,
InputRejectedEventArgs e)
... handle error ...
End Sub

Turning now to formatting and parsing data—suppose an administrator is binding data to a form. FIG. 7 illustrates a system 700 whereby an input 702 can be received from an application. More particularly, data 702 can be received from an application (e.g., SQL Server query written by a database development team). Therefore, the administrator does not control the format of the original data. Following a corporate standard, the query returns dates in the format DD-MM-YYYY. The designer, however, wants users to input dates in the more familiar MM/DD/YYYY format.

In accordance thereto, the administrator needs to convert to this format before the data is bound to this control or it will cause an error in mask 104 validation. As well, the data needs to be converted back to the native query format before it is sent back to the application to avoid an error in the query. Fortunately, the administrator is aware that the Format( ) event can be captured during data binding and therefore, this conversion can be performed manually. Likewise, the administrator can convert from the mask 104 format back to the format expected by the query via the Parse( ) event.

The final exemplary scenario of the subject invention is directed toward creating a new masked control. In this scenario, the designer is aware that controls exist other than the MaskedTextBox control and wants to add masking to them. Specifically, the designer wants to create a MaskComboBox control. Since, in accordance with the subject invention, masking can be exposed as a service, this task can be accomplished by Subclassing the ComboBox control.

Additionally, the masked control, its properties and events can be implemented and associated to the UITypeEditor with mask functionality. Calling MaskedEditProvider.ToDisplayString( ) to render the mask string in the control also enables the designer to effect the ComboBox control. Overriding OnKeyPress on the ComboBox to call MaskedEditProvider, to check that the user input matches the mask is yet another way to accomplish this task. Still another method is to detect insertions and deletions in the middle of the string via keystroke events, and to implement logic to refresh the mask (e.g., by calling MaskedEditProvider.ToString( )) and re-insert the cursor. It will be appreciated that refreshing an entire string is sometimes inefficient and can result in flicker. In order to develop an efficient rendering, a developer can enumerate over the mask characters and refresh only those characters that require updating.

The following runtime aspects and exemplary features and services are provided to add context to the invention for discussion purposes. It is to be understood that the any of the following features and/or services can be employed in combination or individually without departing from the scope and/or utility of the subject invention. Referring again to FIG. 7, a string acceptor component 704 and parsing component 706 are provided. It will be understood that the parsing component 706 (e.g., service) can be included within the character analyzer component 106 to evaluate characters (e.g., string) as a function of a defined mask component 104.

The parsing service 706 is a class that can be called to facilitate testing whether a string or a series of input characters received via the string acceptor component 702 matches a mask. The parsing component 706, e.g., MaskedEditProvider, utilizes the data in arriving with the determination. For example, the parsing component 706 (e.g., parser) determines whether prompts and/or literals are displayed in the Text or Cut/Copy operations. As well, in connection with making its determination, character analyzer component 106, together with the parsing component 706 can ascertain the character used for prompting and the mask 104 used for processing the characters.

In accordance with the subject invention, the parsing component 706, e.g., MaskedEditProvider can be stateful. In other words, the parsing component 706 can add and remove characters into the slots 204 of the mask 104 over successive method calls. This aspect can support verification of the mask 104 as a user is typing.

In one aspect, the methods (e.g., AddCharacter( ) and RemoveCharacter( )) can allow characters to be added or removed in response to character insertions and deletions. Both methods will take an integer indicating the position of the inserted or deleted character. It is to be understood that third-party implementers will have to know the character position of the cursor. For TextBox, ComboBox, and similar controls, this position can be retrieved via a SelectionStart property. In alternate aspects, the engine can also support adding and removing character ranges. The subject invention can support a Clear( ) method that resets the state of MaskedEditProvider so that a developer can begin verifying a new set of data.

To allow third-party developers to render the current mask string in their control, the subject invention can provide a method that renders the mask in its current state into a string, with or without the prompts. It can be the responsibility of the third-party developer to reset the cursor to the correct location in the string, or to iterate over the string's characters and perform selective update on the rendered string. An additional method can be provided to test an entire string for conformance to the mask. For example, this optional method can be used in data binding, when verifying direct assignments to the control's Text property, or when verifying mask completion prior to the control losing focus.

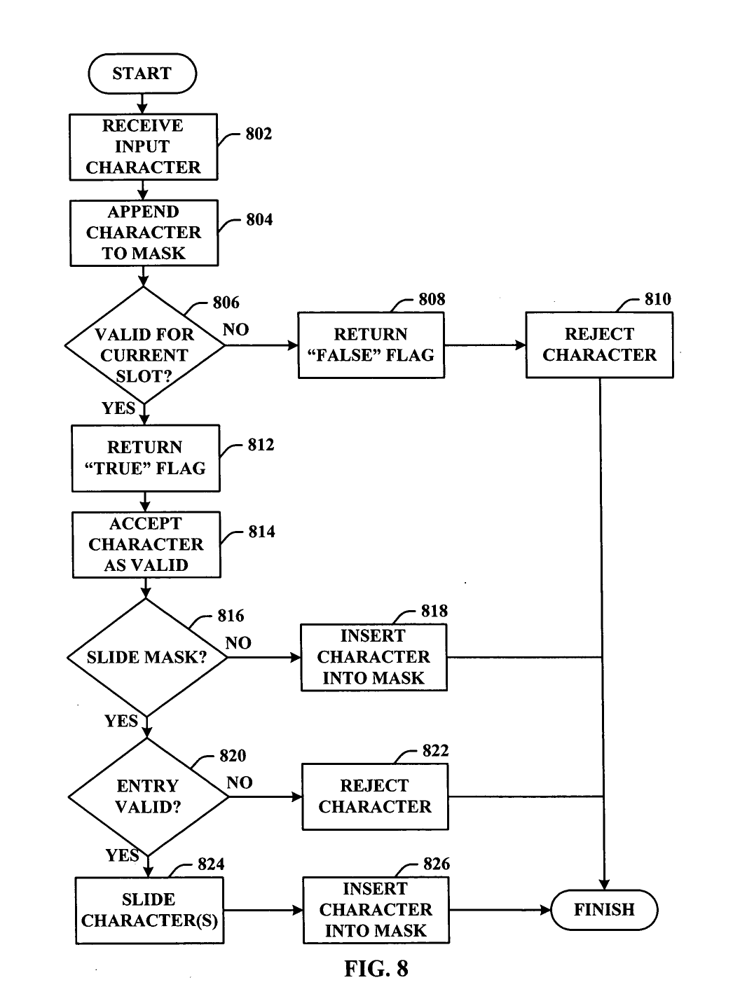

FIG. 8 illustrates an exemplary flow chart in accordance with one aspect of adding and/or removing characters. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the subject invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

In operation, at 802, a character input is received. At 804 the character is appended to the mask. A confirmation check can be performed to verify confirmation to the current character position (e.g., slot) in the mask at 806. If the input character does not conform, a “false” flag can be returned at 808 and the character is rejected at 810. On the other hand, if the character received does conform to the current position in the mask, a “true” flag is returned at 812 and the instant character is accepted as a valid input at 814.

Next, a determination will be made regarding the validity of the character with respect to the mask as a whole. In other words, when a character is inserted into the middle of the mask input, the engine must be able “slide” the displaced characters down the mask successfully without violating the mask format. At 816, a determination is made if a slide is necessary to insert the character. If not, the character will be inserted into the current position of the mask at 818.

If at 816, a determination is made that a slide is necessary, the system then, at 820, checks to determine if the sliding the character(s) will be valid in accordance with the mask. If a slide will violate the mask format, the character is rejected at 822. If sliding will not violate, at 824, the previously entered character(s) is moved into position (e.g., slid) and the new character is inserted into the mask at 826.

It will be appreciated that an insertion will fail if either the current character does not satisfy the mask criterion for that position, or sliding the displaced characters will violate other mask criteria. By way of example, if the mask is “AAA00” (e.g., three required alphanumerics, two required digits), and the current mask input is “ZZZ3”, inserting another “Z” at position 1 will cause the third “Z” in the input to slide into the fourth position in the mask. Since the fourth position must be a digit in accordance with the exemplary syntax described supra, this slide cannot occur, and the engine will reject the insertion.

A similar rule holds for deletions. If Mask is “000A” (e.g., three required digits, one required alphanumeric), and the input is “123B”, the user will not be able to delete any of the numbers without deleting “B” first, since the slide would violate the mask. It will be appreciated that both the insert and delete operations can “slide around” any literals in the mask. For example, if the defined Mask is “000@000”, and the current string is “123@456”, deleting “3” will leave “124@56_” in accordance with the mask. It is to be appreciated that a parser can be provided to reject any non-printable character as invalid.

Turning now to a discussion of the MaskedTextBox control. The subject invention can create a MaskedTextBox control that inherits from TextBoxBase. In one aspect, the following base class members can be hidden in the MaskedTextBox. These members can be marked Browsable(false) and EditorBrowsable(Never).

Properties

AcceptsTab

CanUndo

Lines

MaxLength

Modified

Multiline

WordWrap

Events (and Corresponding Add/On/Remove Methods)

AcceptsTabChanged

ModifiedChanged

MultiLineChanged

Methods

ClearUndo

GetLineFromCharINdex

GetFirstCharIndexFromLine

GetFirstCharIndexOfCurrentLine

ScrollToCaret

Undo

Continuing with a discussion of the Text, OutputText properties, the MaskedTextBox can employ two additional string properties to handle the control's text—a read/write InputText property and a read-only OutputText property. This is because the text property can be tied to the text stored in the system edit control. The Text property can return the Text being displayed to the user. This means that if HidePromptOnLeave is “true”, the value of the Text property will depend on whether the control has focus. The InputText property is used to set Text into the control. It will be appreciated that setting this property follows similar rules as copying and pasting a string into the control. The OutputText property returns the string filtered by the IncludeLiterals and InlcudePromptChars property.

The TextBox control can act as a multi-line control. However, it will be appreciated that aspects can be provided that will not support multi-line in this version (e.g., MaskedTextBox). For example, if a developer sets the multi-line property to true, the subject invention can silently do nothing.

The MaskedTextBox can optionally display “prompt characters.” The prompt characters are indications to the user that input is required for a given line. The PromptCharacter property can control what character acts as the prompt. PromptCharacter can have a default value of “_”. It will be appreciated that any character can be employed as the prompt character in lieu of the default character provided. An IncludePrompt property can determine whether prompts appear when the value is read with the OutputText property of MaskedTextBox. In one aspect, when the control loses focus, the prompt characters will not be displayed unless the user sets the HidePromptOnLeave property to “false.”

Insertions into MaskedTextBox can be serial, e.g., with data flowing into MaskedTextBox according to both the current RightToLeft and LeftToRight. When RightToLeft=False, data will flow from the left to the right, and vice versa when RightToLeft=True. Users will be able to use the mouse or other pointing device to locate the cursor at any point in the MaskedTextBox. For example, the user can place the cursor where data has already been entered, but will not be able to place the cursor between two prompt characters. As previously described, if the user deletes a selection, the remaining characters can “slide” down the mask. Also, if sliding is not accepted by the mask definition, the delete operation will be cancelled. This operation is discussed in more detail infra with reference to the “Cut/Copy of MaskedTextBox Value” operation(s). It is to be appreciated that, within a textbox, the user can only enter characters within the mask—e.g., any area of the text box before or beyond the mask is non-editable.

With reference to arbitrary cursor positions in the MaskedTextBox, if a user clicks into the MaskedTextBox with the pointing device (e.g., mouse), the cursor will be located at the character clicked on. It will be appreciated that the cursor can also be moved right and left with the arrow keys. With regard to committing values/type property, MaskedTextBox can allow focus to shift off of itself even if the user has entered a partial mask value. If the Type property is set, the subject invention can parse the value as that type. If parsing fails, an error event (e.g., TypeValidationCompleted Event) can be raised.

Turning now to error reporting, as discussed supra, MaskedTextBox can support an event, e.g., MaskInputRejected, which can inform the developer when a mask violation has occurred. A possible reason for a violation is that the input character does not match the mask criterion for the current position. Also, adding or removing a character that causes a slide that results in a mask violation is another exemplary instance of error reporting. Yet another exemplary instance for error reporting is if the user is trying to input extraneous characters at the end of the mask. In this situation, the subject invention can detect that the mask has been filled thus prompting an error and subsequent reporting. In an aspect, a developer can catch MaskInputRejected and supply custom inline help—e.g., a dialog or a tooltip. In another aspect, if a developer does not handle MaskInputRejected, an audible beep can be played when this event occurs—e.g., if BeepOnError is set to true.

The timing of the event ordering can be controlled in accordance with specified triggering schemes. For example, the MaskInputRejected can fire after the KeyPress event. If MaskInputRejected does not fire, and a character is accepted into the mask, TextChanged( ) can fire after the input is rendered. Similarly, TypeVerifyFailed( ) can fire before Validating. Therefore, developers can implement even finer-grained validation logic (e.g., looking up a unique ID in a database).

As previously discussed, the subject invention can employ security features, e.g., PasswordChar property and UseSystemPasswordChar, so that entered characters can be rendered in the mask in a protected format. For example, this is particularly useful for applications such as online banking that request a social security number or other well-formed, personal and/or confidential data.

In an aspect, the OutputText property on the MaskedTextBox can return text either with or without prompt characters, depending on whether IncludePrompt is “true” or “false,” and with or without literals, depending on whether IncludeLiterals is “true” or “false.” The return value of OutputText will include the actual user input, regardless of whether PasswordChar is set or not. As previously described, PasswordChar can conceal the rendering of data by employing a protected format such as an asterisk (“*”)

TextBoxBase can have a SelectedText property, which MaskedTextBox can inherit. In accordance with the exemplary aspect, SelectedText will not include Prompt characters, and will include literals depending on the value of the CutCopyLiteral property. One common use of the Text property is to retrieve a value for back-end storage. A particularly common use of Cut and Copy, however, is to export a value outside of the current application. Given this, Cut/Copy operations will not include prompt characters. Whether or not they include literals will be determined by the CutCopyLiterals property. In operation, when a MaskedTextBox's text is cut, the control can revert to displaying the mask with its prompt characters. Cut operations can follow the rules for adding and removing characters specified supra. In other words, if a Cut operation would result in a mask violation, the cut can be cancelled, and a MaskInputRejected error thrown.

Assignments to the InputText property will not respect the IncludeLiterals and IncludePrompt settings on MaskedTextBox. Setting InputText can be equivalent to typing the string. Each character can be checked against the mask in order and rejected if they do not match. Pasting into the MaskedTextBox can have the same effect as assigning to InputText—IncludeLiterals, IncludePrompt, etc. will not be respected.

If the mask property is changed, and text is non-zero-length, therefore, text can be erased. It will be appreciated that this is consistent with the behavior of conventional applications of text masking (e.g., both the VB and Access brand implementations). For example, if the developer sets Mask=“ ”, the current value of Text will not be erased. Rather, in this situation, the subject invention can regenerate the string without the prompt characters, refresh MaskedTextBox with the new string, and Clear( ) MaskedEditProvider of its current values.

As discussed supra, MaskedTextBox can respect the ReadOnly property. In other words, if ReadOnly=True, the Mask should not display. Additionally, the aspects of the subject invention are compatible with existing MaskEdBox (e.g., VB-brand designer) applications. The following table illustrates some notes about how MaskEdBox properties can map to MaskedTextBox.

| VB Property | .Net Property | Comment |
|---|---|---|
| AllowPrompt | AllowPromptAsInput | |
| AutoTab | EnableAutoTab | |
| ClipMode = | EnableCutCopyLiterals = | |
| mskExcludeLiterals | False | |
| ClipMode = | EnableCutCopyLiterals = | |
| mskIncludeLiterals | True | |
| ClipText | OutputText | Issue warning explaining |
| | | Literals may be included |
| | | depending on the |
| | | value of IncludeLiterals |
| Format | No Map | |
| Formatted Text | OutputText | Issue warning explaining |
| | | this will depend on the |
| | | values of |
| | | IncludeLiterals and |
| | | IncludePrompt |
| Mask | Mask | |
| PromptCharacter | PromptCharacter | |
| IncludePrompt | IncludePrompt | |
| ValidationError | MaskInputRejected | MaskInputRejected will |
| | | not include the params |
| | | that ValidationError |
| | | does. We need to |
| | | hammer this out. |

If a MaskedTextBox is data bound to a null value, the MaskedTextBox can behave the same as a regular TextBox. It will be appreciated that setting InputText to null is equivalent to setting the text to“ ”.

Design Time Features

The following design time aspects and exemplary features and services are provided to add context to the invention for discussion purposes. It is to be understood that the any of the following features and/or services can be employed in combination or individually without departing from the scope and/or utility of the subject invention. For example, it is be understood that any toolbox icon for the MaskedTextBox can be employed in connection with the subject invention.

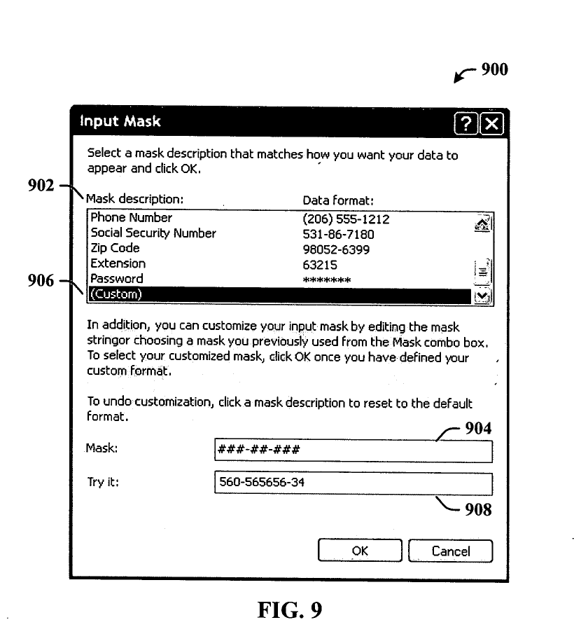

With regard to the mask editor, the input mask wizard can be wired up to the mask property as a UITypeEditor. It can also be available as a link from a MaskedTextBox object bound smart tag. This dialog can make it particularly easier for developers to select a “canned” mask from a list of common masks. As well, the dialog will add a new mask to the list, or edit an existing mask. Moreover, it will test a custom mask before dismissing the dialog. The UITypeEditor can be a single, self-contained dialog 900 as illustrated in FIG. 9.

As described supra, a predefined boilerplate list 902 of masks can be provided in accordance with the subject invention. Following is an exemplary list of default boilerplate masks that can be provided with aspects of the subject invention.

| Mask Name | Mask String | ValidatingType |
|---|---|---|
| Phone number w/ area code | (999)000-0000 | Null |
| Phone number w/o area code | 000-0000 | Null |
| Social security number | 000-00-0000 | Null |
| Short Date | 00/00/0000 | DateTime |
| Short Date + Time (US) | 00/00/0000 90:00 | DateTime |
| Time (US) | 90:00 | DateTime |
| Time (European/Military) | 00:00 | DateTime |

It is to be appreciated that the subject invention can employ a localization component to conform boilerplate or canned mask(s) to a localized custom and/or format. For example, as discussed in the exemplary scenarios above, phone numbers with an area code will appear differently in Japan (e.g., inclusion of a country code). As such, the subject invention is capable of localizing a custom and/or canned mask to local values.

In operation, when the dialog 900 first displays, there can be no item selected in the mask list. If the user selects a canned mask, the mask definition can display in the mask textbox 904. The user will be free to edit this mask as desired. When a change to the selected mask is made, the “(Custom)” list box item 906 is selected in the list of canned masks as illustrated in FIG. 9. If the “(Custom)” list box item 906 is chosen directly, the mask field should be cleared if no custom mask was previously created or the mask field should show current custom mask if such mask was previously defined.

Alternatively, a user can also type a mask directly into the mask textbox 904. In one aspect, this textbox 904 will allow only a single line of input, and will not allow insertion of non-printable characters. Although, the exemplary textbox is limited to a single line of text, it will be appreciated that alternative textbox capacities can be provided in accordance with alternate aspects.

The developer can use the “Try It” box 908 to enter and test input against the mask. This box will be an instance of MaskedTextBox, with its mask value set to the current value of the mask textbox. If the developer changes any attribute of the mask, the text in the “Try It” textbox 908 will be cleared. When the developer chooses a canned mask 902 and makes a change to it, the “(Custom)” item 906 in the list box becomes selected as illustrated in FIG. 9. If the user wants to reset the mask, the canned mask in the list 902 again. When a mask string is chosen, it can be displayed in the property grid of the UI and the string can be editable. The MaskedTextBox can have an object bound smart tag to access the Mask property UITypeEditor. This can be a DesignerAction Method item and the text can be “Set Mask . . . ”.

In accordance with an aspect of the subject invention, the list of boilerplate or canned masks can be modified as desired. As well, the list can be appended or changed to include predefined and/or downloaded masks. In one aspect, a third party can add custom masks that will appear in the list of canned masks in the UITypeEditor. In accordance thereto, each mask entry requires the identification of a mask name, mask string, sample string and validating type. In order to provide third party support, an abstract base class can be created that represents a mask and utilizes the ITypeDiscoveryService to find all types that inherit from this base class.

A MaskDescriptor class can be used for third party mask picker extensibility. Below is an example of such a class:

```
public abstract class MaskDescriptor
    public abstract string Mask { get; }
    public abstract string Name { get; }
    public abstract string SampleOutput { get; }
    public abstract Type ValidatingType { get; }
```

Globalization issues can be addressed with respect to aspects of the subject invention. As discussed supra, it particularly important that MaskedTextBox is compatible with the most used Input Method Editors (IMEs)—for example, Japanese, Chinese and Korean. By way of example, consider the Japanese IME. When the IME is in Hiragana or Katakana mode, MaskedTextBox should not send a character for processing to MaskedEditProvider before composition of the character is complete (e.g., before the composition and candidate windows are closed). The MaskedTextBox can integrate with IMEs in a similar manner to the appropriate control (e.g., VB-brand designers). This can effect the control to listen for WM_IME_STARTCOMPOSITION, WM_IME_COMPOSITION, and WM_IME_CHAR window messages.

The MaskedTextBox can support combined characters. To do this, the subject invention can merge two characters using the proper string parsing application program interfaces (APIs). When two characters are merged together, they will only take up one character mask slot instead of two. If a combining character is entered after the last character in the mask, it will still be accepted and merged into the last position. It will be appreciated that this is implemented to take the full string as entered, pass it to StringInfo.ParseCombiningCharacters and then pass the resulting characters into the MaskEditProvider.

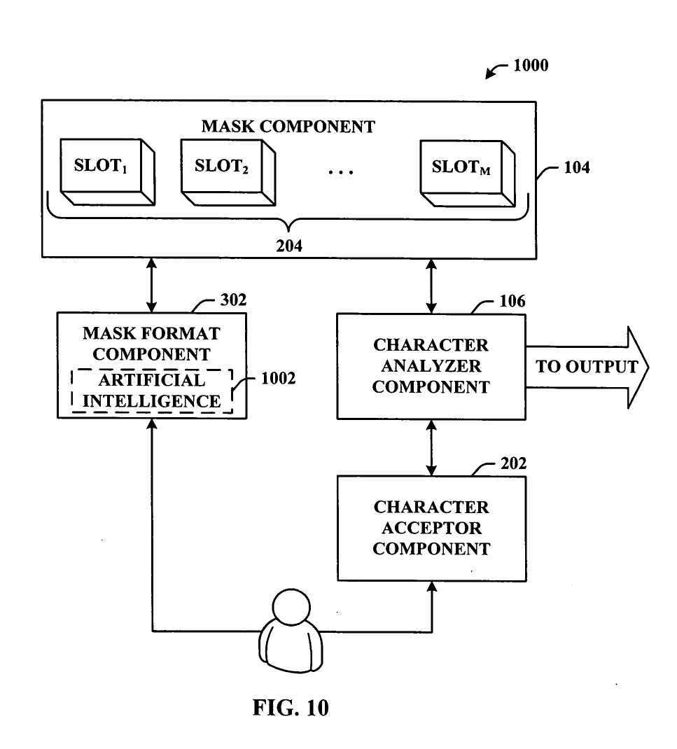

FIG. 10 illustrates yet another alternate aspect of the subject invention. Particularly, the system 1000 of FIG. 10 employs an artificial intelligence (AI) component 1002 in connection with the mask format component 302. Although the system 1000 employs the AI component 1002 in connection with the mask format component 302, it is to be appreciated that a similar AI component can be employed to automatically perform actions and/or functionality described in connection with the subject invention.

Referring again to FIG. 10, the subject invention (e.g., in connection with mask formatting) can employ various AI based schemes for carrying out various aspects thereof. For example, a process for determining a mask from a predefined set or for formatting a mask can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of mask configuration, for example, attributes can be words or phrases or other data-specific attributes derived from the words (e.g., database tables, the presence of key terms), and the classes are categories or areas of interest (e.g., levels of priorities).

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically perform a number of functions, including but not limited to determining according to a predetermined criteria which mask to employ or generate.

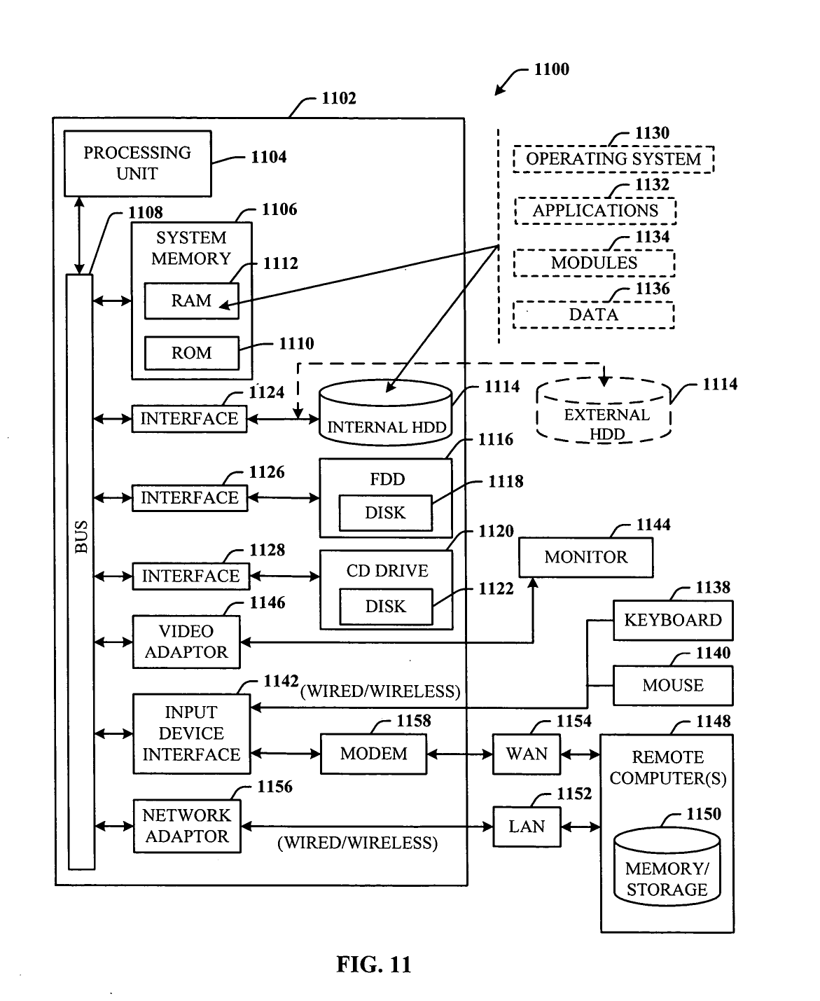

Referring now to FIG. 11, there is illustrated a block diagram of a computer operable to execute the disclosed architecture. In order to provide additional context for various aspects of the subject invention, FIG. 11 and the following discussion are intended to provide a brief, general description of a suitable computing environment 1100 in which the various aspects of the subject invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, there is illustrated an exemplary environment 1100 for implementing various aspects of the invention that includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the subject invention.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the subject invention can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156. When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with conventional network or simply an ad hoc communication between at least two devices.

Wi-Fi, or Wireless Fidelity, allows connection to the Internet from a couch at home, a bed in a hotel room or a conference room at work, without wires. Wi-Fi is a wireless technology like a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

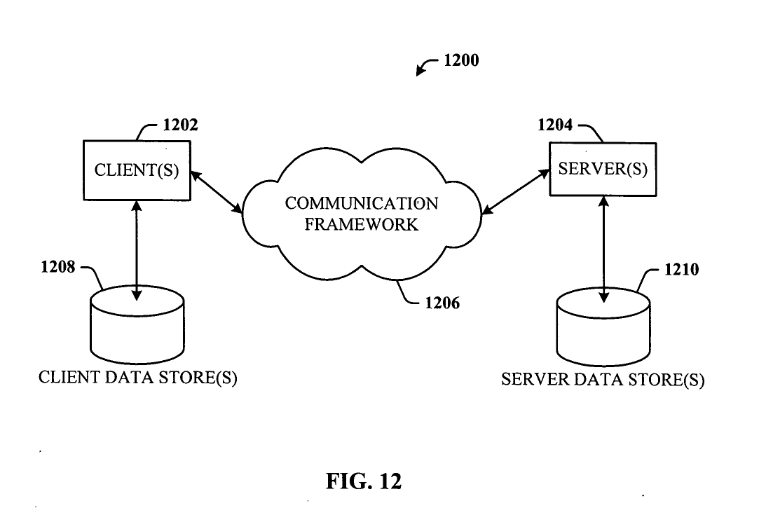

Referring now to FIG. 12, there is illustrated a schematic block diagram of an exemplary computing environment 1200 in accordance with the subject invention. The system 1200 includes one or more client(s) 1202. The client(s) 1202 can be hardware and/or software (e.g., threads, processes, computing devices). The client(s) 1202 can house cookie(s) and/or associated contextual information by employing the subject invention, for example. The system 1200 also includes one or more server(s) 1204. The server(s) 1204 can also be hardware and/or software (e.g., threads, processes, computing devices). The servers 1204 can house threads to perform transformations by employing the subject invention, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

Exemplary Specification

Following is an exemplary specification in accordance with the subject invention described supra. It is to be understood that this specification is to provide context to the invention and is not intended to be limiting in any way. Those skilled in the art will understand that the subject invention can be practiced in accordance with this or an equally enabling specification.

MaskedTextBox

```
public Class MaskedTextBox: TextBoxBase {
    // Constructors
    public MaskedTextBox( );
    public MaskedTextBox(string maske);
    public MaskedTextBox(MaskedTextProvider maskedTextProvider);
    // Properties
    public string Mask { get; set; }
    public char PromptCharacter { get; set; }
    public MaskedTextBoxIncludeMode IncludePrompt { get; set; }
    public bool AllowPromptAsInput { get; set; }
    public bool HidePromptOnLeave { get; set; }
    public MaskedTextBoxIncludeMode IncludeLiterals { get; set; }
    public Type ValidatingType { get; set; }
    public bool BeepOnError { get; set; }
    public bool MaskCompleted { get; set; }
    public bool MaskFull { get; set; }
    public bool UseSystemPasswordChar { get; set; }
    public char PasswordChar { get; set; }
    public bool IsOverwriteMode { get; set; }
    public MaskedTextBoxInsertMode InsertMode { get; set; }
    public IFormatProvider FormatProvider { get; set; }
    public string Text { get; set; }
    public MaskedTextProvider MaskedTextProvider { get; }
public bool AsciiOnly { get; set; }
public CultureInfo Culture { get; set; }
public bool SkipLiterals { get; set; }
public bool ResetOnPrompt { get; set; }
public bool ResetOnSpace { get; set; }
public bool RejectInputOnFirstFailure { get; set; }
    // Events
    event MaskInputRejected MaskInputRejectedEventHandler;
    event TypeValidationCompleted TypeValidationEventHandler;
    event TextChanged EventHandler;
    // Methods
    public object ValidateText( ) { }
```

MaskedTextBox
public class System.Windows.Forms.MaskedTextBox

MaskedTextBox Constructor

public MaskedTextBox ( )

Args

Behavior Creates a new MaskedTextBox.

MaskedTextBox Constructor

public MaskedTextBox (string mask)

| | |
|---|---|
| Args | String mask: the string to initialize the Mask to |
| Behavior | Creates a new MaskedTextBox with the given Mask |

MaskedTextBox Constructor

public MaskedTextBox (MaskedTextProvider maskedTextProvider)

| | |
|---|---|
| Args | MaskedTextProvider maskedTextProvider: The |
| | MaskedTextProvider to use for this MaskedTextBox. |
| Behavior | The Mask and any other state assigned to this provider will be |
| | used in the created control. |

Mask Property

public string Mask {get; set;}

| | |
|---|---|
| Type | String |
| Name | Mask |
| Args | strMask: A single string value representing the mask |
| Behavior | Setting a Mask clears out any previous mask assigned to the |
| | TextBox control. If the string in the Text property is not |
| | empty when the mask is set, the string is evaluated |
| | against the new mask. |
| | Setting a Mask to the empty string causes the TextBox to |
| | revert to its default behavior (accept all inputs). |
| Security | No security implications. |
| Exceptions | ArgumentException if mask is invalid. The criteria |
| | for invalid masks: |
| | Contains non-printable characters anywhere in the mask. |
| Attributes | Localizable(true) |

PromptCharacter Property

public char PromptCharacter {get; set;}

| | |
|---|---|
| Type | String |
| Name | PromptCharacter |
| Behavior | The character displayed to the user to prompt for input in |
| | the masked field. |
| Security | No security implications. |
| Exceptions | None. |
| Attributes | [DefaultValue(“_”)], Localizable(true) |

PasswordChar Property

public char PasswordChar {get; set;}

| | |
|---|---|
| Type | char |
| Name | PasswordChar |
| Behavior | If set, the MaskedTextBox will display this character for all |
| | input into the control. |
| Security | No security implications. |

IncludePrompt Property

public MaskedTextBoxIncludeMode IncludePrompt {get; set;}

| | |
|---|---|
| Type | MaskedTextBoxIncludeMode |
| Name | IncludePrompt |
| Behavior | Whether to print the PromptCharacter for unsupplied values in |
| | the Text property and cut and copy operations. When |
| | disabled in either the Text property or for an operation, |
| | the prompt characters are turned into spaces in the string |
| | returned. |
| Security | No security implications. |
| Attributes | [DefaultValue(IncludeInTextAndCopy)] |

AllowPromptAsInput Property

public bool AllowPromptAsInput {get; set;}

| | |
|---|---|
| Type | Bool |
| Name | AllowPromptAsInput |
| Behavior | Whether PromptCharacter is allowed as valid input in |
| | the mask. The prompt character still must be valid input |
| | in the current position in the mask. |
| | If AllowPromptAsInput = True, and the |
| | current mask character is “#”, |
| | PromptCharacter would not be allowed, since |
| | “#” demands digits only. |
| Security | No security implications. |
| Exceptions | None. |
| Attributes | [DefaultValue(true)] |

HidePromptOnLeave Property

public bool HidePromptOnLeave {get; set;}

| | |
|---|---|
| Type | Bool |
| Name | HidePromptOnLeave |
| Behavior | Whether the PromptCharacter is displayed when the |
| | control loses focus. |
| Security | No security implications. |
| Attributes | [DefaultValue(true)] |

IncludeLiterals Property

public MaskedTextBoxIncludeMode IncludeLiterals {get; set;}

| | |
|---|---|
| Type | MaskedTextBoxIncludeMode |
| Name | IncludeLiterals |
| Behavior | Whether to print literal character for unsupplied values |
| | in the Text property and cut and copy operations. When |
| | disabled in either the Text property or for an operation, |
| | the literal characters are removed in the |
| | string returned. |
| Security | No security implications. |
| Attributes | [DefaultValue(IncludeInTextAndCopy)] |

ValidatingType Property

public Type ValidatingType {get; set;}

| | |
|---|---|
| Type | Type |
| Name | ValidatingType |
| Behavior | If defined, a masked control implementation should use |
| | this value to parse the text when the user leaves the control. |
| | If the type check fails, the VerifyTypeFailedEvent |
| | should be raised. |
| Security | No security implications. |

BeepOnError Property

public bool BeepOnError {get; set;}

| | |
|---|---|
| Type | Bool |
| Name | BeepOnError |
| Behavior | Specifies whether to play the system beep when a user types |
| | input that does not match the mask. |
| Security | No security implications. |
| Attributes | [DefaultValue(false)] |

MaskCompleted Property

public bool MaskCompleted {get;}

| | |
|---|---|
| Type | Bool |
| Name | MaskCompleted |
| Behavior | Returns true is all required input has been entered into the |
| | mask |
| Security | No security implications. |

MaskFull Property

public bool MaskFull {get;}

| | |
|---|---|
| Type | Bool |
| Name | MaskFull |
| Behavior | Returns true if all optional and required input has been |
| | entered into the mask. |
| Security | No security implications. |

UseSystemPasswordChar Property

public bool UseSystemPasswordChar {get; set;}

| | |
|---|---|
| Type | bool |
| Name | UseSystemPasswordChar |
| Behavior | If true, the MaskedTextBox is in password mode and the |
| | password character is that specified by the system. This |
| | property overrides PasswordChar. |
| Security | No security implications. |

IsOverwriteMode Property

public bool IsOverwriteMode {get;}

| | |
|---|---|
| Type | bool |
| Name | IsOverwriteMode |
| Behavior | Returns the current state of overwrite mode for the |
| | MaskedTextBox. This takes into account the InsertMode |
| | property and the state of the users keyboard. |
| Security | No security implications. |

InsertMode Property

public MaskedTextBoxInsertMode InsertMode {get; set;}

| | |
|---|---|
| Type | MaskedTextBoxInsertMode |
| Name | InsertMode |
| Behavior | One of the MaskedTextBoxInsertMode enumeration |
| | members. Controls the insert behavior of the control. This |
| | can be set to always on, always off or respect the setting |
| | of the users keyboard. When insert mode is off |
| | (either by setting it to always off or the user has the |
| | keyboard set to insert = off) the MaskedTextBox insert |
| | behavior will emulate that of Access. |
| Security | No security implications. |

FormatProvider Property

public IFormatProvider FormatProvider {get; set;}

| | |
|---|---|
| Type | IFormatProvider |
| Name | FormatProvider |
| Behavior | Specifies the IFormatProvider to be used when Parsing the |
| | string to the ValidatingType. Defaults to null. |
| Security | No security implications. |

Text Property

public string Text {get; set;}

| | |
|---|---|
| Type | string |
| Name | Text |
| Behavior | The Text property will return a string based on the settings of |
| | IncludePrompt and IncludeLiterals. The setter of the Text |
| | property will behave the same as pasting. That is, it will |
| | either process the whole string, raising input rejected |
| | events as errors are encountered, or it will fail on the |
| | first error encountered if the RejectInputOnFirstFailure |
| | property is true. |
| | The Text property can be databound. |
| Security | No security implications. |

MaskedTextProvider Property

public MaskedTextProvider MaskedTextProvider {get;}

| | |
|---|---|
| Type | MaskedTextProvider |
| Name | MaskedTextProvider |
| Behavior | Returns the MaskedTextProvider currently is use by the |
| | control. The returned provider has the same state |
| | (including the text) as the control; all formatting properties |
| | are the same. |
| Security | No security implications. |

AsciiOnly Property

public bool AsciiOnly {get; set;}

| | |
|---|---|
| Type | bool |
| Name | AsciiOnly |
| Behavior | Specifies whether only ASCII characters are accepted |
| | as valid input. |
| Security | No security implications. |

Culture Property

public CultureInfo Culture {get; set;}

| | |
|---|---|
| Type | CultureInfo |
| Name | Culture |
| Behavior | The culture that determines the value of the localizable |
| | mask language separators and placeholders. |
| Security | No security implications. |

SkipLiterals Property

public bool SkipLiterals {get; set;}

| | |
|---|---|
| Type | Bool |
| Name | SkipLiterals |
| Behavior | Specifies whether to skip the current position if non- |
| | editable and the input character has the same value |
| | as the literal at that position. |
| Security | No security implications. |

ResetOnPrompt Property

public bool ResetOnPrompt {get; set;}

| | |
|---|---|
| Type | bool |
| Name | ResetOnPrompt |
| Behavior | Specifies whether to reset and skip the current position |
| | if editable, when the input character has the same value |
| | as the prompt. This property takes precedence over |
| | AllowPromptAsInput. |
| Security | No security implications. |

ResetOnSpace Property

public bool ResetOnSpace {get; set;}

| | |
|---|---|
| Type | bool |
| Name | ResetOnSpace |
| Behavior | Specifies whether to reset and skip the current position |
| | if editable, when the input is the space character. |
| Security | No security implications. |

RejectInputOnFirstFailure Property

public bool RejectInputOnFirstFailure {get; set;}

| | |
|---|---|
| Type | bool |
| Name | RejectInputOnFirstFailure |
| Behavior | Specifies whether to include the mask prompt character |
| | when formatting the text in places where an edit char |
| | has not being assigned. |
| Security | No security implications. |

MaskInputRejected Event

public event MaskInputRejectedEventHandler MaskInputRejected;

| | |
|---|---|
| Type | MaskInputRejectedEventHandler |
| Name | MaskInputRejected |
| Can Cancel | No |
| Behavior | Raised whenever a user enters an input character that |
| | does not match the current position in the mask, as |
| | determined by MaskedTextProvider. This event can be |
| | handled to implement custom error dialogs (e.g., an |
| | error tooltip). |
| Security | No security implications. |

TypeValidationCompleted Event

public event TypeValidationEventHandler TypeValidationCompleted;

| | |
|---|---|
| Type | TypeValidationEventHandler |
| Name | TypeValidationCompleted |
| Can Cancel | No |
| Behavior | Raised whenever the user commits the value in the |
| | MaskedTextBox. |
| | This happens when navigating between controls on an app |
| | but not when switching focus between applications. Also, |
| | this event needs to be raised when the InputText is set |
| | programmatically. |
| Security | No security implications. |

TextChanged Event

public event EventHandler TextChanged

| | |
|---|---|
| Type | EventHandler |
| Name | TextChanged |
| Can Cancel | No |
| Behavior | Raised whenever the Text property changes. |
| Security | No security implications. |

ValidateText

public object ValidateText( ) { }

| | |
|---|---|
| Type | Object |
| Name | ValidateText |
| Args | |
| Behavior | Calling this method attempts to convert the Text property to |
| | an object of the Type specified by the ValidatingType |
| | property. This will raise the TypeValidationCompleted |
| | event when completed. |
| Security | No security implications. |

InsertKeyMode Enumeration

public enum InsertKeyMode

```
public enum InsertKeyMode
  {
  /// <devdoc>
  ///  Forces insertion mode to be ‘on’ regardless of the Insert key mode.
  /// </devdoc>
  Insert,
  /// <devdoc>
  ///  Forces insertion mode to be ‘off’ regardless of the Insert key
  mode.
  /// </devdoc>
  Overwrite,
  /// <devdoc>
  ///  Honors the Insert key mode.
  /// </devdoc>
  Default
```

MaskedTextBoxIncludeMode Enumeration

public enum MaskedTextBoxIncludeMode
{
IncludeInText
IncludeInCopy
IncludeInTextAndCopy
NeverInclude
}

MaskedTextResultHint Enumeration

public enum MaskedTextResultHint
{
AlphanumericCharacterExpected
AsciiCharacterExpected
CharacterEscaped
DigitExpected
InvalidInput
LetterExpected
NoEffect
NonEditPosition
PositionOutOfRange
PromptCharNotAllowed
SideEffect
SignedDigitExpected
Success
UnavailableEditPosition
Unknown
}

MaskInputRejectedEventArgs

```
public class MaskInputRejectedEventArgs: EventArgs {
  public MaskInputRejectedEventArgs (int position,
MaskedTextResultHint rejectionHint);
  public int Position { get; }
  public MaskedTextResultHint Hint { get; }
}
```

MaskInputRejectedEventArgs

public class System.Windows.Forms.MaskInputRejectedEventArgs

Position Property

public int Position {get;}

| | |
|---|---|
| Type | int |
| Name | Position |
| Behavior | Returns the character position that failed the mask. |
| Security | No security implications. |

Hint Property

public MaskedTextResultHint Hint {get;}

```
public class TypeValidationEventArgs: EventArgs {
  public TypeValidationEventArgs (Type validatingType, bool
isValidInput, object validatedObject, string message);
  public Type ValidatingType { get; }
  public bool IsValidInput { get; }
  public string Message { get; }
  public object ValidatedObject { get; }
  public bool Cancel { get; set; }
```

TypeValidationEventArgs

public class System.Windows.Forms.TypeValidationEventArgs

| | |
|---|---|
| Type | MaskedTextResultHint |
| Name | Hint |
| Behavior | Returns a hint the developer can use to understand why the |
| | input failed. |
| Security | No security implications. |

ValidatedObject Property

public object ValidatedObject {get;}

| | |
|---|---|
| Type | object |
| Name | ValidatedObject |
| Behavior | Returns the object that was being created. |
| Security | No security implications. |

Message Property

public string ErrorMessage {get;}

| | |
|---|---|
| Type | string |
| Name | Message |
| Behavior | Returns the exception string returned while attempting to |
| | create the object. |
| Security | No security implications. |

IsValidInput Property

public bool IsValidInput {get;}

| | |
|---|---|
| Type | bool |
| Name | IsValidInput |
| Behavior | Returns whether the type validation succeeded. |
| Security | No security implications. |

ValidatingType Property

public Type ValidatingType {get;}

| | |
|---|---|
| Type | Type |
| Name | ValidatingType |
| Behavior | Returns the type that the string was being validated against. |
| Security | No security implications. |

Cancel Property

public bool Cancel {get; set;}

| | |
|---|---|
| Type | bool |
| Name | Cancel |
| Behavior | When set to true, it cancels the validation operation and sets |
| | focus back to the MaskedTextBox. |
| Security | No security implications. |

MaskedTextProvider

public Class MaskedTextProvider

```
public Class MaskedTextProvider {
  // Constructors
  public MaskedTextProvider (String mask)
  public MaskedTextProvider (String mask, bool restrictToASCII)
  public MaskedTextProvider (String mask, CultureInfo culture)
  public MaskedTextProvider (String mask, CultureInfo culture, bool
restrictToASCII)
  public MaskedTextProvider (String mask, Char passwordChar, bool
allowPromptAsInput)
  public MaskedTextProvider (String mask, CultureInfo culture, Char
passwordChar, bool allowPromptAsInput)
  public MaskedTextProvider (String mask, CultureInfo culture, bool
allowPromptAsInput, Char promptChar, Char passwordChar, bool
restrictToASCII)
  // Properties
  public string Mask( ) { get;set;}
  public bool IncludePrompt { get; set; }
  public char PromptChar { get; set; }
  public char PasswordChar { get; set; }
  public bool AllowPromptAsInput { get; set; }
  public bool IncludeLiterals { get; set; }
  public bool MaskCompleted { get; set; }
  public bool MaskFull{ get; set; }
  public bool IsPassword { get; }
  public int LastAssignedPostion { get; }
  public int Length { get; }
  public int EditPositionCount { get; }
public bool AsciiOnly { get; }
public Int32 AssignedEditPositionCount { get; }
public Int32 AvailableEditPositionCount { get; }
public CultureInfo Culture { get; }
public Char DefaultPasswordChar { get; }
public IEnumerator EditPositions { get; }
public bool SkipLiterals { get; set }
public bool ResetOnPrompt { get; set }
public bool ResetOnSpace { get; set }
public Int32 InvalidIndex { get; }
// Methods
  public bool VerifyString(string input) { }
public bool VerifyString (String input, ref Int32 testPosition, ref
MaskedTextResultHint resultHint)
public bool Add(char input);
public bool Add (Char input, ref Int32 testPosition, ref
MaskedTextResultHint resultHint)
public bool Add(string input);
public bool Add (String input, ref Int32 testPosition,
ref MaskedTextResultHint resultHint)
public bool InsertAt(char input, int pos);
public bool InsertAt (Char input, Int32 pos, ref Int32 testPos, ref
MaskedTextResultHint resultHint)
public bool InsertAt(string input, int pos);
public bool InsertAt (String input, Int32 pos, ref Int32 testPosition, ref
MaskedTextResultHint resultHint)
public bool Remove( );
public bool Remove (ref Int32 testPosition, ref MaskedTextResultHint
resultHint)
public bool RemoveAt(int pos);
public bool RemoveAt(int startPos, int endPos);
public bool RemoveAt (Int32 startPos, Int32 endPos, ref Int32
testPosition, ref MaskedTextResultHint, resultHint);
public bool Replace(char input, int pos);
public bool Replace (Char input, Int32 pos, ref Int32 testPosition, ref
MaskedTextResultHint resultHint)
public bool Replace (Char input, Int32 startPos, Int32 endPos, ref Int32
testPosition, ref MaskedTextResultHint resultHint)
public bool Replace(string input, int startPos);
public bool Replace (String input, Int32 pos, ref Int32 testPosition, ref
MaskedTextResultHint resultHint)
public bool Replace (String input, Int32 startPos, Int32 endPos, ref Int32
testPosition, ref MaskedTextResultHint resultHint)
  public void Clear( ) { }
  public Void Clear (ref MaskedTextResultHint resultHint)
  public string ToString( ) { }
public string ToString (bool ignorePasswordChar)
public string ToString (Int32 startPos, Int32 length)
public string ToString (bool ignorePasswordChar, Int32 startPos,
Int32 length)
public string ToString (bool includePrompt, bool includeLiterals)
public string ToString (bool includePrompt, bool includeLiterals, Int32
startPos, Int32 length)
public string ToString (bool ignorePasswordChar, bool includePrompt,
bool includeLiterals, Int32 startPos, Int32 length)
  public string ToDisplayString( ) { }
  public int FindAssignedEditPositionFrom(int pos, bool direction) { }
  public int FindEditPositionFrom(int pos, bool direction) { }
  public int FindUnassignedEditPositionFrom(int pos, bool direction) { }
  public Int32 FindAssignedEditPositionInRange (Int32 startPos, Int32
endPos, bool direction)
public Int32 FindEditPositionInRange (Int32 startPos, Int32 endPos, bool
direction)
public Int32 FindUnassignedEditPositionInRange (Int32 startPos, Int32
endPos, bool direction)
  public string GetInputText( )
  public string GetInputText(int startPos, int length)
  public bool IsAvailablePosition (int pos)
  public bool IsEditPosition (int pos)
  public bool Set (String input)
public bool Set (String input, ref Int32 testPosition, ref
MaskedTextResultHint resultHint)
public static bool GetOperationResultFromHint (MaskedTextResultHint
hint)
public static bool IsValidInputChar (Char c)
public static bool IsValidPasswordChar (Char c)
public bool VerifyChar (Char input, Int32 pos, ref MaskedTextResultHint
hint)
public bool VerifyEscapeChar (Char input, Int32 pos)
}
```

MaskedTextProvider

MaskedTextProvider Constructor

public MaskedTextProvider (string mask)

Args String mask: The mask string used to shape input into the provider.

Behavior Creates a new MaskedTextProvider with the given mask.

MaskedTextProvider Constructor

public MaskedTextProvider (string mask, bool restricToAscii)

| | |
|---|---|
| Args | String mask: The mask string used to shape input into the |
| | provider. Bool restrictToAscii: A bool specifying whether |
| | only ASCII input characters are allowed. |
| Behavior | Creates a new MaskedTextProvider with the given mask. |

MaskedTextProvider Constructor

public MaskedTextProvider (string mask, CultureInfo culture)

| | |
|---|---|
| Args | String mask: The mask string used to shape input into the |
| | provider. CultureInfo Culture: The culture used to set the |
| | separator characters. |
| Behavior | Creates a new MaskedTextProvider with the given mask and |
| | the separator characters from the given culture. If the culture |
| | parameter is null, the current culture is used. |

MaskedTextProvider Constructor

public MaskedTextProvider (string mask, CultureInfo culture, bool restricToAscii)

| | |
|---|---|
| Args | String mask: The mask string used to shape input into the |
| | provider. CultureInfo Culture: The culture used to set the |
| | separator characters. Bool restrictToAscii: A bool specifying |
| | whether only ASCII input characters are allowed. |
| Behavior | Creates a new MaskedTextProvider with the given mask and |
| | the separator characters from the given culture. If the culture |
| | parameter is null, the current culture is used. |

MaskedTextProvider Constructor

public MaskedTextProvider (string mask, bool passwordChar, bool allowPromptAsInput)

| | |
|---|---|
| Args | String mask: The mask string used to shape input into the |
| | provider. Bool passwordChar: The character that will be |
| | shown for characters entered into a password string. |
| | Bool allowPromptAsInput: A bool specifying whether the |
| | prompt character should be allowed as a valid input character. |
| Behavior | Creates a new MaskedTextProvider with the given mask. |

MaskedTextProvider Constructor

public MaskedTextProvider (string mask, CultureInfo culture, bool passwordChar, bool allowPromptAsInput)

| | |
|---|---|
| Args | String mask: The mask string used to shape input into the |
| | provider. CultureInfo Culture: The culture used to set the |
| | separator characters. Bool passwordChar: The character |
| | that will be shown for characters entered into a password |
| | string. Bool allowPromptAsInput: A bool specifying whether |
| | the prompt character should be allowed as a valid input |
| | character. |
| Behavior | Creates a new MaskedTextProvider with the given mask and |
| | the separator characters from the given culture. If the culture |
| | parameter is null, the current culture is used. |

MaskedTextProvider Constructor

public MaskedTextProvider (string mask, CultureInfo culture, bool passwordChar, bool allowPromptAsInput, bool restrictToAscii)

| | |
|---|---|
| Args | String mask: The mask string used to shape input into the |
| | provider. CultureInfo Culture: The culture used to set the |
| | separator characters. Bool passwordChar: The character |
| | that will be shown for characters entered into a password |
| | string. Bool allowPromptAsInput: A bool specifying whether |
| | the prompt character should be allowed as a valid input |
| | character. Bool restrictToAscii: A bool specifying whether |
| | only ASCII input characters are allowed. |
| Behavior | Creates a new MaskedTextProvider with the given mask and |
| | the separator characters from the given culture. If the culture |
| | parameter is null, the current culture is used. |

Mask

public char Mask {get; set;}

| | |
|---|---|
| Type | String |
| Name | Mask |
| Args | A string representing a valid mask. |
| Behavior | |
| Security | No security implications. |
| | ArgumentException if mask is invalid. Currently we have |
| | two criteria for invalid masks: |
| Exceptions | Contains non-printable characters anywhere in the mask. |
| | Contains no actual input mask variables - i.e., it consists |
| | solely of <, >, “.”, “,”, /, &, and/or literals. |

IncludePrompt Property

public bool IncludePrompt {get; set;}

| | |
|---|---|
| Type | bool |
| Name | IncludePrompt |
| Behavior | Whether to print the PromptCharacter for unsupplied values |
| | in the Text property. When false the Text property the prompt |
| | characters are turned into spaces in the string returned. |
| Security | No security implications. |

PromptCharacter Property

public char PromptCharacter {get; set;}

| | |
|---|---|
| Type | String |
| Name | PromptCharacter |
| Behavior | The character displayed to the user to prompt for input in |
| | the masked field. |
| Security | No security implications. |
| Attributes | [DefaultValue(“_”)], Localizable(true) |

PasswordChar Property

public char PasswordChar {get; set;}

| | |
|---|---|
| Type | char |
| Name | PasswordChar |
| Behavior | If set, the MaskedTextBox will display this character for all |
| | input into the control. |
| Security | No security implications. |

AllowPromptAsInput Property

public bool AllowPromptAsInput {get; set;}

| | |
|---|---|
| Type | Bool |
| Name | AllowPromptAsInput |
| | Whether PromptCharacter is allowed as |
| | valid input in the mask. |
| Behavior | The prompt character still must be valid input in the |
| | current position in the mask. If AllowPromptAsInput=True, |
| | and the current mask character is “#”, |
| | PromptCharacter would not be allowed, |
| | since “#” demands digits only. |
| Security | No security implications. |

IncludeLiterals Property

public bool IncludeLiterals {get; set;}

| | |
|---|---|
| Type | bool |
| Name | IncludeLiterals |
| Behavior | Whether to print literal character for unsupplied |
| | values in the Text property. When false the |
| | Text property, the literal characters are removed |
| | in the string returned. |
| Security | No security implications. |

MaskCompleted Property

public bool MaskCompleted {get;}

| | |
|---|---|
| Type | Bool |
| Name | MaskCompleted |
| Behavior | Returns true is all required input |
| | has been entered into the mask |
| Security | No security implications. |

MaskFull Property

public bool MaskFull {get;}

| | |
|---|---|
| Type | Bool |
| Name | MaskFull |
| Behavior | Returns true if all optional and required |
| | input has been entered into the mask. |
| Security | No security implications. |

IsPassword

public bool IsPassword {get;}

| | |
|---|---|
| Type | bool |
| Name | IsPassword |
| Args | |
| Behavior | Returns whether the text is to be |
| | displayed as a password. |
| Security | No security implications. |

LastAssignedPostion

public int LastAssignedPostion {get;}

| | |
|---|---|
| Type | int |
| Name | LastAssignedPostion |
| Args | |
| Behavior | The last edit position (relative to the origin not |
| | to time) in the test string where an input |
| | character has been placed. If no position |
| | has been assigned, InvalidIndex is returned. |
| Security | No security implications. |

Length

public int Length {get;}

| | |
|---|---|
| Type | int |
| Name | Length |
| Args | |
| Behavior | Returns the length of the test string |
| Security | No security implications. |

EditPositionCount

public int EditPositionCount {get;}

| | |
|---|---|
| Type | int |
| Name | EditPositionCount |
| Args | |
| Behavior | Returns the count of available character |
| | entry positions in the mask. |
| Security | No security implications. |

AsciiOnly Property

public bool AsciiOnly {get;}

| | |
|---|---|
| Type | bool |
| Name | AsciiOnly |
| Behavior | Specifies whether only ASCII characters |
| | are accepted as valid input. |
| Security | No security implications. |

Culture Property

public CultureInfo Culture {get;}

| | |
|---|---|
| Type | CultureInfo |
| Name | Culture |
| Behavior | The culture that determines the value |
| | of the localizable mask language |
| | separators and placeholders. |
| Security | No security implications. |

SkipLiterals Property

public bool SkipLiterals {get; set;}

| | |
|---|---|
| Type | Bool |
| Name | SkipLiterals |
| Behavior | Specifies whether to skip the current |
| | position if non-editable and the input |
| | character has the same value as the |
| | literal at that position. |
| Security | No security implications. |

ResetOnPrompt Property

public bool ResetOnPrompt {get; set;}

| | |
|---|---|
| Type | bool |
| Name | ResetOnPrompt |
| Behavior | Specifies whether to reset and skip the |
| | current position if editable, when |
| | the input character has the same |
| | value as the prompt. This property takes |
| | precedence over AllowPromptAsInput. |
| Security | No security implications. |

ResetOnSpace Property

public bool ResetOnSpace {get; set;}

| | |
|---|---|
| Type | bool |
| Name | ResetOnSpace |
| Behavior | Specifies whether to reset and skip the |
| | current position if editable, when |
| | the input is the space character. |
| Security | No security implications. |

AssignedEditPositionCount Property

public int AssignedEditPositionCount {get;}

| | |
|---|---|
| Type | int |
| Name | AssignedEditPositionCount |
| Behavior | Retrieves the number of editable characters that have been set. |
| Security | No security implications. |

AvailableEditPositionCount Property

public int AvailableEditPositionCount {get;}

| | |
|---|---|
| Type | int |
| Name | AvailableEditPositionCount |
| Behavior | Retrieves the number of editable characters that have been set. |
| Security | No security implications. |

DefaultPasswordChar Property

public char DefaultPasswordChar {get;}

| | |
|---|---|
| Type | char |
| Name | DefaultPasswordChar |
| Behavior | The system password char. |
| Security | No security implications. |

EditPositions Property

public IEnumerator EditPositions {get;}

| | |
|---|---|
| Type | IEnumerator |
| Name | EditPositions |
| Behavior | Returns a new IEnumerator object containing |
| | the editable positions in the test string. |
| Security | No security implications. |

InvalidIndex Property

public int InvalidIndex {get; set;}

| | |
|---|---|
| Type | int |
| Name | InvalidIndex |
| Behavior | A negative value representing an index outside the test string. |
| Security | No security implications. |

VerifyString

public bool VerifyString(string input) { }

| | |
|---|---|
| Type | bool |
| Name | VerifyString |
| Args | String input: A string representing the current input. |
| Behavior | Verifies the test string against the mask. |
| Security | No security implications. |
| Exceptions | No exceptions. |

VerifyString

public bool VerifyString(string input, ref Int32 testPosition, ref MaskedTextResultHint resultHint) { }

| | |
|---|---|
| Type | bool |
| Name | VerifyString |
| Args | String input: A string representing the |
| | current input. |
| | Int testPosition: On exit the testPosition |
| | contains last position where the |
| | primary operation was actually performed |
| | if successful, otherwise the |
| | first position that made the test fail. |
| | This position is relative to the test |
| | string. |
| | MaskedTextResultHint resultHint: |
| | The MaskedTextResultHint out |
| | param gives more information about |
| | the operation result. |
| Behavior | Verifies the test string against the mask. |
| | On exit the testPosition contains |
| | last position where the primary |
| | operation was actually performed |
| | if successful, otherwise the first |
| | position that made the test fail. This |
| | position is relative to the test string. |
| | The MaskedTextResultHint out param |
| | gives more information about the |
| | operation result. |
| | Returns true on success, false otherwise. |
| Security | No security implications. |
| Exceptions | No exceptions. |

Add

public bool Add(char input) { }

| | |
|---|---|
| Type | bool |
| Name | Add |
| Args | Input: The character to add. |
| Behavior | Attempts to add the specified character to the last |
| | unoccupied positions in the test string (append text to |
| | the virtual string). Returns true on success, false otherwise. |
| Security | No security implications. |
| Exceptions | No exceptions. |

Add

public bool Add(char input, ref Int32 testPosition, ref MaskedTextResultHint resultHint)

| | |
|---|---|
| Type | bool |
| Name | Add |
| Args | Input: The character to add. |
| | Int testPosition (ref): On exit the testPosition contains last position where |
| | the primary operation was actually performed if successful, otherwise the |
| | first position that made the test fail. This position is relative to the test |
| | string. |
| | MaskedTextResultHint resultHint (ref): On exit, the |
| | MaskedTextResultHint out param gives a hint about the operation result |
| | reason. |
| Behavior | Attempts to add the specified character to the last unoccupied positions |
| | in the test string (append text to the virtual string). |
| | On exit the testPosition contains last position where the primary |
| | operation was actually performed if successful, otherwise the first |
| | position that made the test fail. This position is relative to the test string. |
| | The MaskedTextResultHint out param gives a hint about the operation |
| | result reason. |
| | Returns true on success, false otherwise. |
| Security | No security implications. |
| Exceptions | No exceptions. |

Add

public bool Add(string input) { }

| | |
|---|---|
| Type | bool |
| Name | Add |
| Args | Input: The string to add. |
| Behavior | Attempts to add the characters in the specified string |
| | to the last unoccupied positions in the test string |
| | (append text to the virtual string). Returns true on |
| | success, false otherwise. |
| Security | No security implications. |
| Exceptions | No exceptions. |

Add

public bool Add(string input, ref Int32 testPosition, ref MaskedTextResultHint resultHint)

| | |
|---|---|
| Type | bool |
| Name | Add |
| Args | Input: The string to add. |
| | Int testPosition (ref): On exit the testPosition contains last position where |
| | the primary operation was actually performed if successful, otherwise the |
| | first position that made the test fail. This position is relative to the test |
| | string. |
| | MaskedTextResultHint resultHint (ref): On exit, the |
| | MaskedTextResultHint out param gives a hint about the operation result |
| | reason. |
| Behavior | tempts to add the characters in the specified string to the last unoccupied |
| | positions in the test string (append text to the virtual string). |
| | On exit the testPosition contains last position where the primary operation |
| | was actually performed if successful, otherwise the first position that made |
| | the test fail. This position is relative to the test string. |
| | The MaskedTextResultHint out param gives a hint about the operation |
| | result reason. |
| | Returns true on success, false otherwise. |
| Security | No security implications. |

InsertAt

public bool Insert(char input, int pos) { }

| | |
|---|---|
| Type | bool |
| Name | InsertAt |
| Args | input: The character to add. |
| | pos: The position at which to insert the character. |
| Behavior | Attempts to insert the specified character at the specified |
| | position in the test string. (Insert character in the virtual |
| | string). |
| | Returns true on success, false otherwise. |
| Security | No security implications. |
| Exceptions | No exceptions. |

InsertAt

public bool Insert(char input, int pos, ref Int32 testPos, ref MaskedTextResultHint resultHint)

| | |
|---|---|
| Type | bool |
| Name | InsertAt |
| Args | Char input: The character to add. |
| | Int pos: The position at which to insert the character. |
| | Int testPosition (ref): On exit the testPosition contains last position where |
| | the primary operation was actually performed if successful, otherwise the |
| | first position that made the test fail. This position is relative to the test |
| | string. |
| | MaskedTextResultHint resultHint (ref): On exit, the |
| | MaskedTextResultHint out param gives a hint about the operation result |
| | reason. |
| Behavior | Attempts to insert the specified character at the specified position in the |
| | test string, shifting characters at upper positions (if any) to make room |
| | for the input. |
| | On exit the testPosition contains last position where the primary |
| | operation was actually performed if successful, otherwise the first |
| | position that made the test fail. This position is relative to the test string. |
| | The MaskedTextResultHint out param gives more information about the |
| | operation result. |
| | Returns true on success, false otherwise. |
| Security | No security implications. |
| Exceptions | No exceptions. |

InsertAt

public bool InsertAt(string input, int pos) { }

| | |
|---|---|
| Type | bool |
| Name | InsertAt |
| Args | String input: The string to add. |
| | Int pos: The position at which to insert the character. |
| Behavior | Attempts to insert the characters in the specified |
| | string in at the specified position in the test string. |
| | (Insert characters in the virtual string). |
| | Returns true on success, false otherwise. |
| Security | No security implications. |
| Exceptions | No exceptions. |

InsertAt

public bool InsertAt(string input, int pos, ref Int32 testPosition, ref

| | |
|---|---|
| Type | bool |
| Name | InsertAt |
| Args | String input: The string to add. |
| | Int pos: The position at which to insert the character. |
| | Int testPosition (ref): On exit the testPosition contains last position where |
| | the primary operation was actually performed if successful, otherwise the |
| | first position that made the test fail. This position is relative to the test |
| | string. |
| | MaskedTextResultHint resultHint (ref): On exit, the |
| | MaskedTextResultHint out param gives a hint about the operation result |
| | reason. |
| Behavior | Attempts to insert the characters in the specified string in at the specified |
| | position in the test string, shifting characters at upper positions (if any) to |
| | make room for the input. |
| | On exit the testPosition contains last position where the primary |
| | operation was actually performed if successful, otherwise the first |
| | position that made the test fail. This position is relative to the test string. |
| | The MaskedTextResultHint out param gives more information about the |
| | operation result. |
| | Returns true on success, false otherwise. |
| Security | No security implications. |
| Exceptions | No exceptions. |

Remove

public bool Remove ( ) { }

| | |
|---|---|
| Type | bool |
| Name | Remove |
| Args | None. |
| | Removes the last character in the mask input. |
| Behavior | When a character is removed, the existing characters in |
| | the mask that are displaced will flow to the left or the right |
| | and fill in the gap. If flowing characters is prevented by the |
| | mask definition, this method will return false, and the |
| | add attempt will fail. |
| Security | No security implications. |
| Exceptions | No exceptions. |

Remove

public bool Remove (ref Int32 testPosition, ref MaskedTextResultHint resultHint) { }

| | |
|---|---|
| Type | bool |
| Name | Remove |
| Args | Int TestPosition (ref): On exit the out param contains the position where |
| | the operation was actually performed. |
| Behavior | MaskedTextResultHint resultHint (ref): The MaskedTextResultHint out |
| | param gives more information about the operation result. |
| | Removes the last character from the formatted string. (Remove last |
| | character in virtual string). On exit the out param contains the position |
| | where the operation was actually performed. |
| | This position is relative to the test string. |
| | The MaskedTextResultHint out param gives more information about the |
| | operation result. |
| | Returns true on success, false otherwise. |
| Security | No security implications. |
| Exceptions | No exceptions. |

RemoveAt

public bool Remove (int position) { }

| | |
|---|---|
| Type | bool |
| Name | Remove |
| Args | Int Position: The position of the character in the mask |
| | which should be removed. |
| Behavior | The position is relative to the full string with all of |
| | its prompt characters included. |
| | When a character is removed, the existing characters in |
| | the mask that are displaced will flow to the and fill in the |
| | gap. If flowing characters is prevented by the mask |
| | definition, this method will return false, and removal of |
| | the character will not occur. |
| Security | No security implications. |
| Exceptions | No exceptions. |

RemoveAt

public bool RemoveCharacters(int startPos, int endpos) { }

| | |
|---|---|
| Type | bool |
| Name | Remove |
| Args | Int startPos: The first character to remove. |
| | Int endPos: The last character to remove. |
| Behavior | The position is relative to the full string |
| | with all of its prompt characters included. |
| | Removes all characters in the specified range. |
| | When a range of characters is removed, the |
| | existing characters in the mask that are displaced |
| | will flow to the and fill in the gap. If flowing in |
| | characters is prevented by the mask definition, this |
| | method will return false, and removal of the character |
| | will not occur. |
| Security | No security implications. |
| Exceptions | No exceptions. |

RemoveAt

public bool RemoveCharacters(int startPos, int endPos, ref Int32 testPosition, ref MaskedTextResultHint, resultHint)

| | |
|---|---|
| Type | bool |
| Name | Remove |
| Args | Int startPos: The first character to remove. |
| | Int endPos: The last character to remove. |
| | The position is relative to the full string with all of its prompt characters |
| | included. |
| | Int testPosition (ref): On exit the testPosition contains last position where |
| | the primary operation was actually performed if successful, otherwise the |
| | first position that made the test fail. This position is relative to the test |
| | string. |
| | MaskedTextResultHint resultHint (ref): The MaskedTextResultHint out |
| | param gives more information about the operation result. |
| Behavior | Removes all characters in edit position from in the test string at the |
| | specified start and end positions and shifts any remaining characters left. |
| | On exit the testPosition contains last position where the primary |
| | operation was actually performed if successful, otherwise the first |
| | position that made the test fail. This position is relative to the test string. |
| | The MaskedTextResultHint out param gives more information about the |
| | operation result. |
| | Returns true on success, false otherwise. |
| Security | No security implications. |
| Exceptions | No exceptions. |

Replace

public bool Replace(char input, int pos) { }

| | |
|---|---|
| Type | bool |
| Name | Replace |
| Args | Char input: The character to add to the mask input. |
| | Int pos: The position of the character to replace with input. |
| Behavior | The position is relative to the full string with all of its |
| | prompt characters included. |
| | Replaces a character in the mask input. |
| Security | No security implications. |
| Exceptions | No exceptions. |

Replace

public bool Replace(char input, int pos, ref Int32 testPosition, ref MaskedTextResultHint resultHint) { }

| | |
|---|---|
| Type | bool |
| Name | Replace |
| Args | Char input: The character to add to the mask input. |
| | Int pos: The position of the character to replace with input. |
| | The position is relative to the full string with all of its prompt characters |
| | included. |
| | Int testPosition: On exit the testPosition contains last position where the |
| | primary operation was actually performed if successful, otherwise the |
| | first position that made the test fail. This position is relative to the test |
| | string. |
| | MaskedTextResultHint resultHint: The MaskedTextResultHint out |
| | param gives more information about the operation result. |
| Behavior | Replaces the first editable character in the test string from the specified |
| | position, with the specified character, unless the character at the specified |
| | position is to be escaped. |
| | On exit the testPosition contains last position where the primary |
| | operation was actually performed if successful, otherwise the first |
| | position that made the test fail. This position is relative to the test string. |
| | The MaskedTextResultHint out param gives more information about the |
| | operation result. |
| | Returns true on success, false otherwise. |
| Security | No security implications. |
| Exceptions | No exceptions. |

Replace

public bool Replace(char input, int pos, Int32 endPos, ref Int32 testPosition, ref MaskedTextResultHint resultHint) { }

| | |
|---|---|
| Type | bool |
| Name | Replace |
| Args | Char input: The character to add to the mask input. |
| | Int pos: The start position of the characters to replace with input. |
| | The position is relative to the full string with all of its prompt characters |
| | included. |
| | Int endPos: The end position of the characters to replace with input. |
| | Int testPosition: On exit the testPosition contains last position where the |
| | primary operation was actually performed if successful, otherwise the first |
| | position that made the test fail. This position is relative to the test string. |
| | MaskedTextResultHint resultHint: The MaskedTextResultHint out param |
| | gives more information about the operation result. |
| Behavior | Replaces the first editable character in the test string from the specified |
| | position, with the specified character and removes any remaining |
| | characters in the range unless the character at the specified position is to be |
| | escaped. |
| | If specified range covers more than one assigned edit character, shift-left is |
| | performed after replacing the first character. This is useful when in a edit |
| | box the user selects text and types a character to replace it. |
| | On exit the testPosition contains last position where the primary operation |
| | was actually performed if successful, otherwise the first position that made |
| | the test fail. This position is relative to the test string. |
| | The MaskedTextResultHint out param gives more information about the |
| | operation result. |
| | Returns true on success, false otherwise. |
| Security | No security implications. |

Replace

public bool Replace(string input, int startPos) { }

| | |
|---|---|
| Type | bool |
| Name | Replace |
| Args | String input: The string to add to the mask input. |
| | Int startPos: The start position of the string to replace with |
| | input. |
| | The position is relative to the full string with all of its prompt |
| | characters included. |
| Behavior | Replaces a range of characters in the mask input. |
| | The engine will attempt to replace every character in the mask |
| | input starting at startPos. If a failure occurs at any position, |
| | the replace will fail, and this method will return false. |
| Security | No security implications. |

Replace

public bool Replace(string input, int startPos, ref Int32 testPosition, ref MaskedTextResultHint resultHint) { }

| | |
|---|---|
| Type | bool |
| Name | Replace |
| Args | String input: The string to add to the mask input. |
| | Int startPos: The start position of the string to replace with input. |
| | The position is relative to the full string with all of its prompt characters |
| | included. |
| | Int testPosition: On exit the testPosition contains last position where the |
| | primary operation was actually performed if successful, otherwise the first |
| | position that made the test fail. This position is relative to the test string. |
| | MaskedTextResultHint resultHint: The MaskedTextResultHint out param |
| | gives more information about the operation result |
| Behavior | places the character at the first edit position from the one specified with the |
| | first character in the input; the rest of the characters in the input will be |
| | placed in the test string according to the InsertMode (insert/replace), |
| | shifting characters at upper positions (if any) to make room for the entire |
| | input. |
| | On exit the testPosition contains last position where the primary operation |
| | was actually performed if successful, otherwise the first position that made |
| | the test fail. This position is relative to the test string. |
| | The MaskedTextResultHint out param gives more information about the |
| | operation result. |
| | Returns true on success, false otherwise. |
| Security | No security implications. |

Replace

public bool Replace(string input, int startPos, Int32 endPos, ref Int32 testPosition, ref MaskedTextResultHint resultHint) {

| | |
|---|---|
| Type | bool |
| Name | Replace |
| Args | String input: The string to add to the mask input. |
| | Int startPos: The start position of the string to replace with input. |
| | The position is relative to the full string with all of its prompt characters |
| | included. |
| | Int endPos: The end position of the characters to replace with input. |
| | Int testPosition: On exit the testPosition contains last position where the |
| | primary operation was actually performed if successful, otherwise the first |
| | position that made the test fail. This position is relative to the test string. |
| | MaskedTextResultHint resultHint: The MaskedTextResultHint out param |
| | gives more information about the operation result. |
| Behavior | Replaces the characters in the specified range with the characters in the |
| | input string and shifts characters appropriately (removing or inserting |
| | characters according to whether the input string is shorter or larger than the |
| | specified range. |
| | On exit the testPosition contains last position where the primary operation |
| | was actually performed if successful, otherwise the first position that made |
| | the test fail. This position is relative to the test string. |
| | The MaskedTextResultHint out param gives more information about the |
| | operation result. |
| | Returns true on success, false otherwise. |

ToString

public string ToString( ) { }

| | |
|---|---|
| Type | String |
| Name | ToString |
| Args | None; operates on the state engine. |
| Behavior | Takes the string and executes the mask against it, |
| | returning a string with PromptCharacter and mask literals |
| | included at the proper places. |
| | ToString( ) will honor IncludePrompt, IncludeLiterals, and |
| | PasswordChar. |

ToString

public string ToString(bool ignorePasswordChar) { }

| | |
|---|---|
| Type | String |
| Name | ToString |
| Args | bool ignorePasswordChar: A boolean indicating whether |
| | the password characters should be used in the |
| | returned string. |
| Behavior | Returns a formatted string based on the mask, honoring the |
| | IncludePrompt and IncludeLiterals properties, and |
| | PasswordChar depending on the value of |
| | the ‘ignorePasswordChar’ parameter. |

ToString

public string ToString(Int32 startPos, Int32 length) { }

| | |
|---|---|
| Type | String |
| Name | ToString |
| Args | Int32 startPos: The start position of the string to return |
| | Int32 length: The end position of the string to return |
| Behavior | Returns a formatted string starting at the specified position |
| | and for the specified number of character, based on the |
| | mask, honoring IncludePrompt and IncludeLiterals |
| | but ignoring PasswordChar. Parameters are relative |
| | to the test string. |

ToString

public string ToString(bool ignorePasswordChar, Int32 startPos, Int32 length) { }

| | |
|---|---|
| Type | String |
| Name | ToString |
| Args | bool ignorePasswordChar: A boolean indicating whether the |
| | password characters should be used in the returned string. |
| | Int32 startPos: The start position of the string to return |
| | Int32 length: The end position of the string to return |
| Behavior | Returns a formatted string starting at the specified position |
| | and for the specified number of character, based on the mask, |
| | honoring the IncludePrompt, IncludeLiterals properties and |
| | PasswordChar depending on the ‘ignorePasswordChar’ |
| | parameter. Parameters are relative to the test string. |

ToString

public string ToString(bool includePrompt, bool includeLiterals) { }

| | |
|---|---|
| Type | String |
| Name | bool includePrompt: A bool indicating whether prompt |
| | characters should be returned in the string. |
| | bool includeLiterals: A bool indicating whether literals |
| | characters should be returned in the string. |
| Args | None; operates on the state engine. |
| Behavior | Returns a formatted string based on the mask, ignoring the |
| | PasswordChar and according to the includePrompt and |
| | includeLiterals parameters. |

ToString

public string ToString(bool includePrompt, bool includeLiterals, Int32 startPos, Int32 length) { }

| | |
|---|---|
| Type | String |
| Name | ToString |
| Args | bool includePrompt: A bool indicating whether prompt |
| | characters should be returned in the string. |
| | bool includeLiterals: A bool indicating whether literals |
| | characters should be returned in the string. |
| | Int32 startPos: The start position of the string to return |
| | Int32 length: The end position of the string to return |
| Behavior | Returns a formatted string starting at the specified position |
| | and for the specified number of character, based on the |
| | mask, according to the ignorePasswordChar, includePrompt |
| | and includeLiterals parameters. Parameters are |
| | relative to the test string. |

ToString

public string ToString(bool ignorePasswordChar, bool includePrompt, bool includeLiterals, Int32 startPos, Int32 length) { }

| | |
|---|---|
| Type | String |
| Name | ToString |
| Args | bool ignorePasswordChar: A boolean indicating whether |
| | the password characters should be used in the returned string. |
| | bool includePrompt: A bool indicating whether prompt |
| | characters should be returned in the string. |
| | bool includeLiterals: A bool indicating whether literals |
| | characters should be returned in the string. |
| | Int32 startPos: The start position of the string to return |
| | Int32 length: The end position of the string to return |
| Behavior | Returns a formatted string starting at the specified position |
| | and for the specified number of character, based on the mask, |
| | according to the ignorePasswordChar, includePrompt and |
| | includeLiterals parameters. Parameters are relative to the |
| | test string. |

ToDisplayString

public string ToDisplayString( ) { }

| | |
|---|---|
| Type | String |
| Name | ToDisplayString |
| Args | None; operates on the state engine. |
| Behavior | Takes the string and executes the mask against it, returning a |
| | string with PromptCharacter and mask literals included |
| | at the proper places. |
| | ToDisplayString( ) will not honor IncludePrompt or |
| | IncludeLiterals; it will always include PromptCharacter (if set) |
| | and all literals. ToDisplayString( ) will honor PasswordChar. |

Clone

public Object Clone( ) { }

| | |
|---|---|
| Type | object |
| Name | Clone |
| Args | |
| Behavior | Returns a MaskedTextProvider with the same properties |
| | (Mask, AllowAsInput, etc.) and the same state. |

Clear

public void Clear( ) { }

| | |
|---|---|
| Type | Void |
| Name | Clear |
| Args | |
| Behavior | Resets the state of the test string. |
| Security | No security implications. |

Clear

public void Clear(ref MaskedTextResultHint resultHint) { }

| | |
|---|---|
| Type | Void |
| Name | Clear |
| Args | MaskedTextResultHint resultHint: The MaskedTextResultHint |
| | out param gives more information about the operation result |
| Behavior | Resets the state of the test string. |

FindAssignedEditPositionFrom

public int FindAssignedEditPositionFrom(int pos, bool direction){ }

| | |
|---|---|
| Type | int |
| Name | FindAssignedEditPositionFrom |
| Args | Int pos: the position in the string to start the search. |
| | Bool direction: true to search forward, false to search |
| | backward |
| Behavior | Gets the position of the first edit char in the test string, the |
| | search starts from the specified position included. Returns |
| | InvalidIndex if it doesn't find one. |

FindEditPositionFrom

public int FindEditPositionFrom(int pos, bool direction) { }

| | |
|---|---|
| Type | int |
| Name | FindEditPositionFrom |
| Args | Int pos: the position in the string to start the search. |
| | Bool direction: true to search forward, false to search |
| | backward |
| Behavior | Gets the position of the first assigned edit char in the test |
| | string, the search starts from the specified position included. |
| | Returns InvalidIndex if it doesn't find one. |

FindUnassignedEditPositionFrom

public int FindUnassignedEditPositionFrom(int pos, bool direction) { }

| | |
|---|---|
| Type | int |
| Name | FindUnassignedEditPositionFrom |
| Args | Int pos: the position in the string to start the search. |
| | Bool direction: true to search forward, false to search |
| | backward |
| Behavior | Gets the position of the first edit char in the test string, the |
| | search starts from the specified position included. |
| | Returns InvalidIndex if it doesn't find one. |

FindAssignedEditPositionInRange

public int FindAssignedEditPositionInRange Int32 startPos, Int32 endPos, bool direction) { }

| | |
|---|---|
| Type | int |
| Name | FindAssignedEditPositionInRange |
| Args | Int startPos: the position in the string to start the search. |
| | Int endPos: the end position in the string for the search. |
| | Bool direction: true to search forward, false to search |
| | backward |
| Behavior | Gets the position of the first edit char in the test string in the |
| | specified range, the search starts from the specified |
| | position included. Returns InvalidIndex if it doesn't find one. |

FindEditPositionInRange

public int FindEditPositionInRange (Int32 startPos, Int32 endpos, bool direction) { }

| | |
|---|---|
| Type | int |
| Name | FindEditPositionInRange |
| Args | Int startPos: the position in the string to start the search. |
| | Int endPos: the end position in the string for the search. |
| | Bool direction: true to search forward, false to search |
| | backward |
| Behavior | Gets the position of the first assigned edit char in the test |
| | string; the search is performed in the specified positions |
| | range and in the specified direction. The positions are |
| | relative to the test string. Returns InvalidIndex if it doesn't |
| | find one. |

FindUnassignedEditPositionInRange

public int FindUnassignedEditPositionInRange (Int32 startPos, Int32 endPos, bool direction) { }

| | |
|---|---|
| Type | int |
| Name | FindUnassignedEditPositionInRange |
| Args | Int startPos: the position in the string to start the search. |
| | Int endPos: the end position in the string for the search. |
| | Bool direction: true to search forward, false to search |
| | backward |
| Behavior | Gets the position of the first edit char in the test string |
| | in the specified range; the search starts from the specified |
| | position included. Returns InvalidIndex if it doesn't find one. |

GetInputText

public string GetInputText( ) { }

| | |
|---|---|
| Type | string |
| Name | GetInputText |
| Args | |
| Behavior | Returns the string entered into the provider. |

IsEditPosition

public bool IsEditPosition(int pos) { }

| | |
|---|---|
| Type | bool |
| Name | IsEditPosition |
| Args | Int pos: the position in the test string to check for edit |
| | availability. |
| Behavior | Checks whether the characters in the input string are valid and |
| | can be inserted and at the specified position. |

IsAvailablePosition

public bool IsAvailablePosition(int pos) { }

| | |
|---|---|
| Type | bool |
| Name | IsAvailablePosition |
| Args | Int pos: the position in the test string to check for availability. |
| Behavior | Checks whether the specified position is available for |
| | assignment. Returns false if it is assigned or it is not |
| | editable, true otherwise. |

Set

public bool Set(string input{ }

| | |
|---|---|
| Type | bool |
| Name | Set |
| Args | String input: A string containing characters to set into the test |
| | string |
| Behavior | Sets the edit characters in the test string to the ones specified |
| | in the input string if all characters are valid. |

Set

public bool Set(string input, ref Int32 testPosition, ref MaskedTextResultHint resultHint) { }

| | |
|---|---|
| Type | bool |
| Name | Set |
| Args | String input: A string containing characters to set into |
| | the test string Int testPosition (ref): Contains the last character |
| | that was inserted if successful, or the |
| | first character that failed. |
| | MaskedTextResultHint resultHint (ref): |
| | Sets the edit characters in the test string to the ones specified |
| | in the input string if all characters are valid. |
| Behavior | On exit the out param contains the position where |
| | the operation was actually performed if successful, |
| | otherwise the first position that made the test fail. |
| | This position is relative to the test string. |
| | The MaskedTextResultHint out param gives more |
| | information about the operation result. If passwordChar |
| | is assigned, it is rendered in the output |
| | string instead of the user-supplied values. |

GetOperationResultFromHint

public static bool GetOperationResultFromHint (MaskedTextResultHint hint) { }

| | |
|---|---|
| Type | bool |
| Name | GetOperationResultFromHint |
| Args | MaskedTextResultHint hint: the hist to test. |
| Behavior | Specifies whether the specified MaskedTextResultHint |
| | denotes success or not. |

IsValidInputChar

public static bool IsValidInputChar (Char c) { }

| | |
|---|---|
| Type | bool |
| Name | IsValidInputChar |
| Args | Char c: the character to test |
| Behavior | Checks whether the specified character is a valid input char. |

IsValidPasswordChar

public static bool IsValidPasswordChar (Char c) { }

| | |
|---|---|
| Type | bool |
| Name | IsValidPasswordChar |
| Args | Char c: the character to test |
| Behavior | Checks whether the specified character is a valid password |
| | char. |

VerifyChar

public bool VerifyChar (Char input, Int32 pos, ref MaskedTextResultHint hint) { }

| | |
|---|---|
| Type | bool |
| Name | VerifyChar |
| Args | Char input: the character to test |
| | Int32 pos: the position to test the char at |
| | MaskedTextResultHint hint (ref): The result hint of the tested |
| | operation |
| Behavior | Tests whether the specified character would be set |
| | successfully at the specified position. |

VerifyEscapeChar

public bool VerifyEscapeChar (Char input, Int32 pos) { }

| | |
|---|---|
| Type | Bool |
| Name | VerifyEscapeChar |
| Args | Char input: the character to test |
| | Int32 pos: the position to test the char at |
| Behavior | Tests whether the specified character would be escaped at the |
| | specified position. |

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates data entry, the system comprising:
a mask engine component that facilitates determination of a valid character from an input of one or more characters with respect to a format; and
an interface component that facilitates employment of the mask engine with disparate types of edit controls.

2. The system of claim 1, the edit control is one of a text box, a combo box, a rich edit, a list view and a cell in a data grid.

3. The system of claim 1, the mask engine comprising:
a mask component that facilitates definition of the format that constrains the input of the one or more characters; and
an analyzer component that determines if the input conforms to the format.

4. The system of claim 3, further comprising a security component that obscures a rendering of the valid character.

5. The system of claim 3, the mask component further comprises a plurality of slots that represent the one or more acceptable characters with respect to the format.

6. The system of claim 5, further comprising a component that accepts the input and communicates the input to the analyzer component.

7. The system of claim 5, further comprising a format component that generates the mask component in accordance with the format.

8. The system of claim 7, the format component further comprises a wizard component, the wizard component having one or more predefined masks.

9. The system of claim 7, the format component further comprises an artificial intelligence (AI) component that employs a statistical-based analysis to infer an action that a user desires to be automatically performed.

10. The system of claim 7, further comprising an AI component that predicts a user intention as a function of historical user criteria.

11. The system of claim 10, the AI component includes an inference component that facilitates automatic generation of the format as a function of the predicted user intention with respect to a characteristic.

12. The system of claim 11, the inference component employs a utility-based analyses in performing the automatic generation.

13. The system of claim 4, the analyzer component having a right-to-left (RTL) component that populates the mask in a predefined order.

14. The system of claim 4, the analyzer component having a component that provides an alert upon an entry of an invalid character as a function of the format.

15. The system of claim 4, the input is a string.

16. The system of claim 15, the analyzer component having a parsing component that separates the string and generates the one or more characters.

17. A desktop computing system that employs the system of claim 1.

18. A portable computing device that employs the system of claim 1.

19. A computer readable medium having stored thereon the components of claim 1.

20. A method of entering data, the method comprising:
defining a format that constrains an input of one or more characters;
employing a mask engine to determine a valid character from the input of the one or more characters with respect to the format; and
interfacing the mask engine into disparate types of edit controls.

21. The method of claim 20, the edit control is one of a text box, a combo box, a rich edit, a list view and a cell in a data grid.

22. The method of claim 20, further comprising obscuring a rendering of the valid character.

23. The method of claim 20, further comprising generating a mask in accordance with the format.

24. The method of claim 23, further comprising employing a wizard to generate the mask.

25. The method of claim 23, further comprising predicting a user intention in connection with generating the mask.

26. The method of claim 20, further comprising populating the mask in an RTL manner.

27. The method of claim 20, the input is a string.

28. The method of claim 27, further comprising parsing the string to separate the string and identify the one or more characters.

29. A computer readable medium having stored thereon computer executable instructions for carrying out the method of claim 20.

30. A text edit control employing the method of claim 20.

31. A service that facilitates encoding allowable entries into a text entry field, the system comprising:
a formatting component that encodes a data mask; the data mask defines a valid data input configuration;
an input component that receives a data string, the data string having one or more characters; and
an analyzer component that determines a valid character from the data string as a function of the data mask.

32. The service of claim 31, the text entry field is integral to one of a text box control, a combo box control, a rich edit control, a list view control and a cell in a data grid.

33. The service of claim 32, further comprising a security component that conceals a display of the valid character.

34. The service of claim 32, further comprising a component that localizes the format to a target geographic region.

35. The service of claim 32, the formatting component includes a wizard component that facilitates encoding the mask.

36. The service of claim 32, the analyzer component further comprises a character recognition component that interprets the data string as a function of the data mask to determine the valid character.

37. The service of claim 36, further comprising a parsing component that determines the one or more characters from the data string.

38. A computer readable medium having stored thereon the components of claim 31.

39. A system that facilitates factoring masking logic into a service, the system comprising:
a state engine component that inserts an initial mask into its constructor;
an input component that passes one or more characters into the state engine; and
an analyzer component that determines if the one or more characters is a valid character based upon and the initial mask.

40. A computer readable medium having stored thereon the components of claim 39.
